(19) United States
(12) Patent Application Publication
(10) Pub. No.: US 2003/0215072 A1
(43) Pub. Date: Nov. 20, 2003

(54) Method and system for rating long distance telephone calls

(75) Inventors: James Dilowe Barker, Bal Harbour, FL (US); Federico Fuentes, Aventura, FL (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: Phone 1 Inc., Miami, FL

(21) Appl. No.: 10/396,291

(22) Filed: Mar. 25, 2003

Related U.S. Application Data
(60) Provisional application No. 60/367,539, filed on Mar. 25, 2002.

(51) Int. Cl. H04M 15/00

(52) U.S. Cl. 379/114.01; 379/114.06

(57) ABSTRACT

A system and method are provided for facilitating rated long distance-telephone calls. The method includes receiving a destination telephone number for a rated long distance telephone call. The method further includes determining a first rate for the telephone call based on the destination number and connecting to a call management system. The method further includes receiving a DTMF tone from the call management system, the DTMF tone corresponding to a second rate for the telephone call. If the first rate is identical to the second rate, a telephone call connection to the destination number is initiated. The telephone call is rated at the first rate.

### CROSS-REFERENCED APPLICATIONS

The present non-provisional application claims priority to provisional patent application serial No. 60/367,539 with inventors Fuentes et al., entitled “PROGRAMMABLE PHONE DEVICE AND METHOD HAVING ENHANCED READY/RATE TABLE TONE” filed Mar. 25, 2002, which is hereby incorporated by reference in its entirety.

### FIELD OF THE INVENTION

The present invention generally relates to the field of pay telephones, and more particularly relates to the rating of long distance telephone calls placed from a pay telephone.

### BACKGROUND OF THE INVENTION

The advent of the telephone in the 1800s was a pivotal moment in human history. Telephones have changed the way people communicate, the way firms do business and even the way countries wage war. In the last century, the telephone has emerged as the most available and widely used mode of telecommunications on the planet. There is an estimated half a billion telephones in use across the globe. As a result, the telecommunications industry has grown into a multi-billion dollar industry.

As the use of telephones has increased, so has the popularity of pay telephones. Pay telephones meet an important social need for many individuals who cannot afford a personal telephone line or who simply do not have a telephone line available to them, as in rural areas. In addition, pay telephones provide international telephone call services for individuals who may have personal telephone lines without international access. International telephone call services on pay phones satisfy a need among large groups of individuals who live in one country but who maintain ties and communications with individuals in another country. International telephone call services on pay telephones are of great satisfy a great need in the United States where large numbers of immigrants reside.

Today, however, international telephone call services on pay telephones come with some drawbacks. The conventional method of allowing international telephone calls on a pay telephone involves a required coin deposit for a rated telephone call period. Typically, the rating of the telephone call can be confusing, as the rating can involve a connection charge, a rate for a first minute of the telephone call period and a different rate for subsequent minutes of the telephone call period. The user is thus required to insert varying amounts of money at different times. Additionally, the rates provided by a pay telephone may be not economic or competitive, as the carrier has not negotiated for optimal pricing.

Another common method of allowing international telephone calls on a pay telephone involves the use of a prepaid telephone card. A prepaid telephone card is typically a card of a certain denomination that is purchased at a variety of stores. To use the prepaid telephone card at a pay telephone, the user must dial an access number, such as a 1-800 number, and wait for a prompt. Subsequently, the user must dial in an authorization code that is printed on the prepaid telephone card. The user then dials in the destination number in order to connect to the receiving party. This system can be tedious and confusing, as it requires the dialing of an exorbitant amount of numbers and following a protocol.

In addition, the rating of the telephone call can be confusing, as the rating can involve a connection charge, a rate for a first minute of the telephone call period and a different rate for subsequent minutes of the telephone call period. Finally, the user is limited to the use of prepaid calling cards in the denominations in which they are available. This limits the purchasing habits of the user to the occasions when he is prepared to spend exactly the amount of the denomination on an international telephone call.

Therefore a need exists to overcome the problems with the prior art as discussed above.

### SUMMARY OF THE INVENTION

Briefly, in accordance with one aspect of the present invention, there is disclosed a method on a telephone for facilitating rated telephone calls. The method includes receiving a destination telephone number for a telephone call. The method further includes determining a first rate for the telephone call based on the destination number and connecting to a call management system. The method further includes receiving a DTMF tone from the call management system, the DTMF tone corresponding to a second rate for the telephone call. If the first rate is identical to the second rate, a telephone call connection to the destination number is initiated. The telephone call is rated at the first rate.

In accordance with another aspect of the present invention, there is disclosed an information processing system for facilitating rated telephone calls. The information processing system comprises an interface for receiving a destination telephone number for a telephone call and a rate table for use by a processor for determining a first rate for the telephone call based on the destination number. The information processing system further comprises a telephony processing system for connecting to a call management system and a Dual-Tone Multi-Frequency (DTMF) tone received from the call management system, the DTMF tone corresponding to a second rate for the telephone call. The information processing system further comprises a processor for determining if the first rate is identical to the second rate.

The preferred embodiments of the present invention are advantageous because they allow for the initiation of an international telephone call from a pay telephone using coin deposits. This is beneficial as it follows a well-known protocol used for pay telephone calls. Further, the user is only required to enter a destination number in order to initiate the call. No additional numbers are required to be dialed. This reduces confusion and chances for error as it minimizes the amount of numbers dialed by the user. Another advantage of the present invention is that the pay telephone routes and rates the telephone call. This is beneficial as it allows for the control of the telephone call to be handled locally.

In accordance with yet another aspect of the present invention, there is disclosed a method on a telephone for facilitating rated telephone calls. The method includes receiving a destination telephone number for a telephone call and determining a first rate for the telephone call based on the destination number. The method further includes playing a first message indicating a first required deposit amount for a first telephone call period based on the first rate and connecting to a call management system. The method further includes receiving a first DTMF tone from the call management system, the first DTMF tone corresponding to a second rate for the telephone call. The method further includes connecting to the destination number if the first rate is identical to the second rate.

The method further includes receiving, at a predetermined time before the first telephone call period has expired, a second DTMF tone from the call management system, the second DTMF tone corresponding to a third rate for a second telephone call period. The method further includes receiving and playing a second message from the call management system, the second message indicating a second required deposit amount for the second telephone call period based on the third rate.

The above embodiment of the present invention is advantageous because the pay telephone routes and rates the telephone call. This is beneficial as it allows for the control of the telephone call to be handled locally. However, the above embodiment allows for telephone call periods subsequent to the initial telephone call period to be rated by the call management system. This is beneficial as it allows for a portion of the control of the telephone call to be handled at a central location, which can be easily maintained and modified.

In accordance with yet another aspect of the present invention, there is disclosed a method on a telephone for facilitating rated telephone calls. The method includes receiving a destination telephone number for a telephone call and connecting to a call management system. The method further includes receiving a first DTMF tone from the call management system, the first DTMF tone corresponding to a first rate for the telephone call and receiving and playing a first message from the call management system, the first message indicating a first required deposit amount for a first telephone call period based on the first rate.

The method further includes receiving, at a predetermined time before the first telephone call period has expired, a second DTMF tone from the call management system, the second DTMF tone corresponding to a second rate for a second telephone call period. The method further includes receiving and playing a second message from the call management system, the second message indicating a second required deposit amount for the second telephone call period based on the second rate.

The above embodiment of the present invention is advantageous because the routing and rating of the telephone call is not performed by the pay telephone. The call routing occurs automatically while the call rating is performed by a call management system. This is beneficial as it allows for a portion of the control of the telephone call to be handled at a central location, which can be easily maintained and modified. Additionally, this eliminates the need for rate information to reside on the pay telephone. Rate information is maintained in one central location, which can be easily maintained and modified.

### BRIEF DESCRIPTION OF THE DRAWINGS

FIG. 1 is a block diagram illustrating a telephone communication system in one embodiment of the present invention.

FIG. 2 is a block diagram illustrating a pay telephone in one embodiment of the present invention.

FIG. 3 is a block diagram illustrating a call management system in one embodiment of the present invention.

FIGS. 4A-4I are an operational flow diagram showing the overall telephone call process according to a first embodiment of the present invention.

FIGS. 5A-5B are an operational flow diagram showing the call-in-progress process according to a second embodiment of the present invention.

FIGS. 6A-6H are an operational flow diagram showing the overall telephone call process according to a third embodiment of the present invention.

FIG. 7 is a block diagram of an information processing system useful for implementing embodiments of the present invention.

### DETAILED DESCRIPTION

The present invention, according to a preferred embodiment, advantageously overcomes problems with the prior art by providing an efficient method for rating long distance telephone calls initiated from a pay telephone, as will be discussed in detail below.

I. Overview

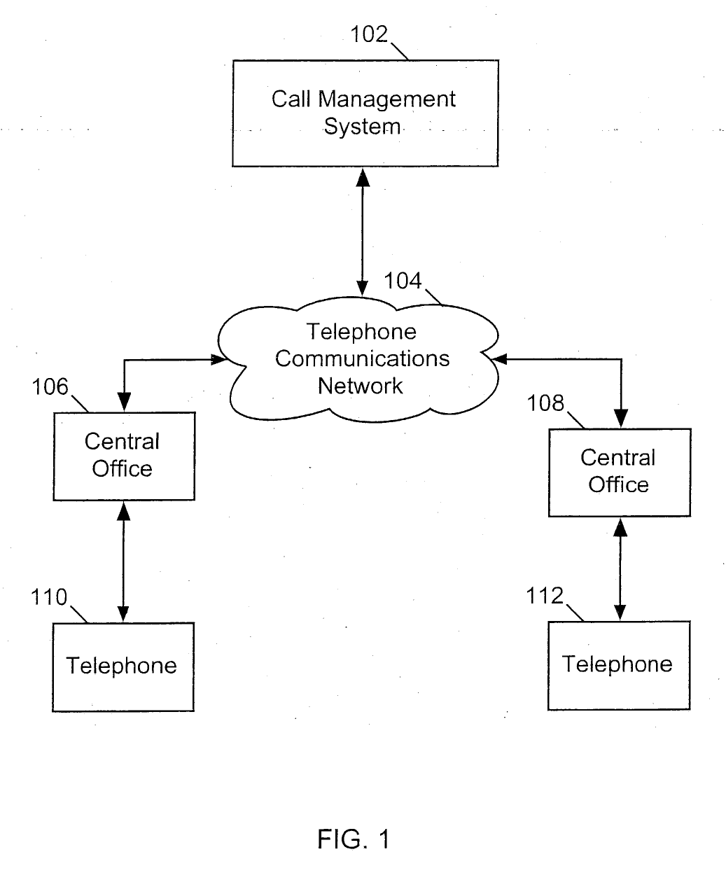

FIG. 1 is a block diagram illustrating a telephone communication system in one embodiment of the present invention. FIG. 1 shows a telephone communications network 104, such as the Public Switched Telephone Network (PSTN). FIG. 1 also shows central offices 106, 108 and telephones 110, 112. A Central Office (CO), also known as a Local Exchange Carrier (LEC), is an exchange or relay station that services a geographical or logical area. For example, all telephones in a geographical area are connected to a CO in that area. The CO in turn is connected to a telephone communications network 104 that provides service to other COs.

Telephones 110 and 112 are standard non-mobile or mobile telephones. Non-mobile telephones are conventional land-line telephones. Mobile telephones are any telephone that provides telephony service via a wireless network. A mobile telephone is a two-way radio capable of receiving and transmitting radio frequency signals over a communication channel under a communications protocol such as Code Division Multiple Access (CDMA), Time Division Multiple Access (TDMA), Global System for Mobile Communications (GSM), General Packet Radio Service (GPRS), Frequency Division Multiple Access (FDMA) or the like.

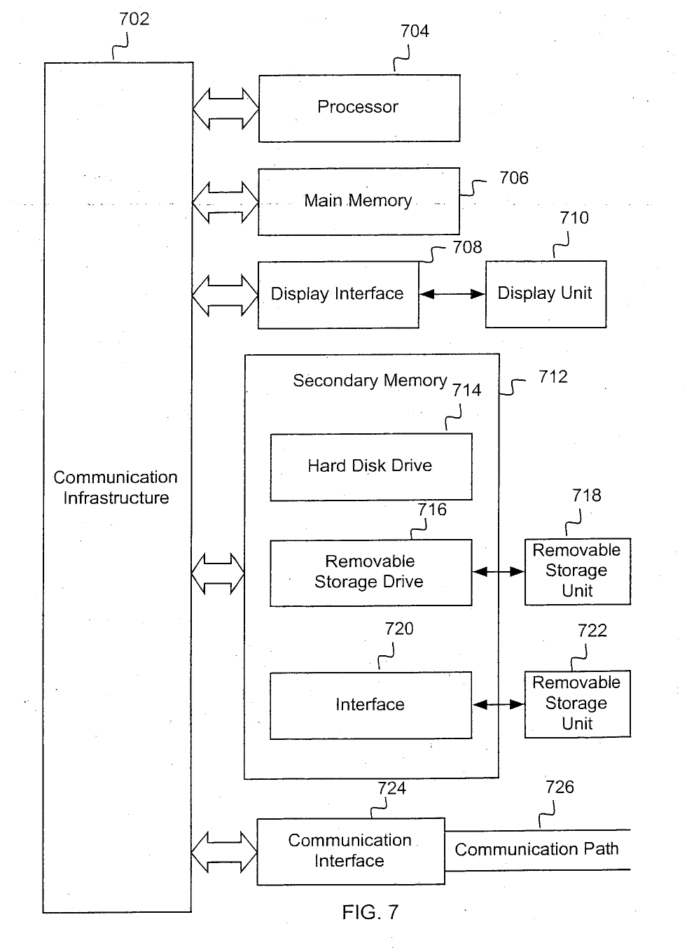

In addition, telephones 110 and 112 can be pay telephones that may be smart pay phones or dumb pay phones. Smart pay phones include a processor for performing rating, routing and/or telephony functions. Such smart phones may also include a computer, as described in greater detail below with reference to FIG. 7. Dumb pay phones are network controlled and do not possess the processing capability of a smart pay phone.

The Call Management System (CMS) 102 of FIG. 1 is a computer or computer system that handles many aspects of the telephone call connection and rating phases of a long distance telephone call in one embodiment of the present invention. CMS 102 is connected to the telephone communications network 104 so as to provide its services to any pay telephone on the network 104. CMS 102 is described in greater detail below.

In the present embodiment, the CMS 102 and/or the COs 106, 108 may comprise one or more Personal Computers (PCs) (e.g., IBM or compatible PC workstations running the Microsoft Windows 95/98/2000/ME/CE/NT/XP operating system, Macintosh computers running the Mac OS operating system, PCs running the LINUX operating system or equivalent), or any other computer processing devices. Alternatively, the CMS 102 and/or the COs 106, 108 may include one or more server systems (e.g., SUN Ultra workstations running the SunOS or AIX operating system, IBM RS/6000 workstations and servers running the AIX operating system or servers running the LINUX operating system). An exemplary computer is described in greater detail below with reference to FIG. 7.

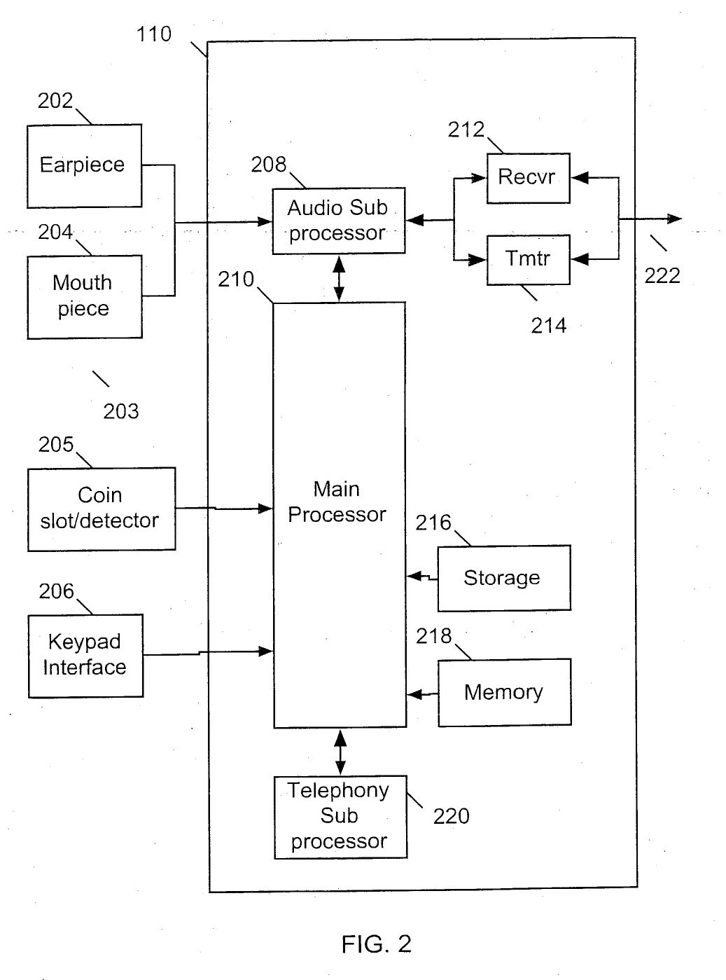

FIG. 2 is a block diagram illustrating more detail of a pay telephone (such as telephones 110 and 1 12) in one embodiment of the present invention. The pay telephone 110 includes a receiver 212 and a transmitter 214 for sending and receiving information over a telephone line 222 that is connected to the telephone communications network 104, typically via a CO such as CO 106. All information sent or received via the receiver 212 and transmitter 214 is processed by an audio sub-processor 208.

The pay telephone 110 shows a main processor 210 that handles a majority of the processes associated with the call routing, call rating, call setup, call maintenance processes of the pay telephone 110. The pay telephone 110 also shows telephony sub-processor 220 that handles processes associated with the call setup and call maintenance processes of the pay telephone 110.

FIG. 2 shows a storage module 216 for storing information such as rate tables, databases, and more, which are used during the overall call process. Rate tables, databases, and the like are described in greater detail below. FIG. 2 also shows a main memory module 218, such as a volatile memory element like a Dynamic Random Access Memory (DRAM) module. The main memory module 218 is used for storing and retrieving data and instructions necessary for performing the functions of pay telephone 110.

External to the pay telephone 110 is the handset 203 comprising the earpiece 202 and the mouthpiece 204. The earpiece 202 includes a small speaker that is placed to a user's ear for listening. The mouthpiece 204 includes a small microphone that is placed to a user's mouth for speaking into. The external portion of the pay telephone 110 also includes a coin slot/detector 205, which comprises an orifice for inserting coins into the pay telephone 110 and for detecting and/or counting the coins that have been inserted into the pay telephone 110.

The pay telephone 110 also includes a keypad interface 206 for entering information. Preferably, the keypad interface 206 includes a conventional series of twelve buttons—comprising the number one through nine, the “*” button and the “#” (pound) button—that produce Dual Tone Multi-Frequency (DTMF) tones when pressed. DTMF tones are tones produced using a combination of two frequencies—one high frequency and one low frequency. COs are programmed to recognize DTMF stones. In addition to the twelve tones associated with the twelve buttons on the pay telephone 110, an additional four tones are also available for use.

As explained above, the CMS 102 is a computer or computer system that handles many aspects of the telephone call connection and rating phases of a long distance telephone call in one embodiment of the present invention. The CMS 102 and/or the COs 106, 108 may comprise one or more PCs or any other computer processing devices. Alternatively, the CMS 102 may include one or more server systems. An exemplary computer is described in greater detail below with reference to FIG. 7.

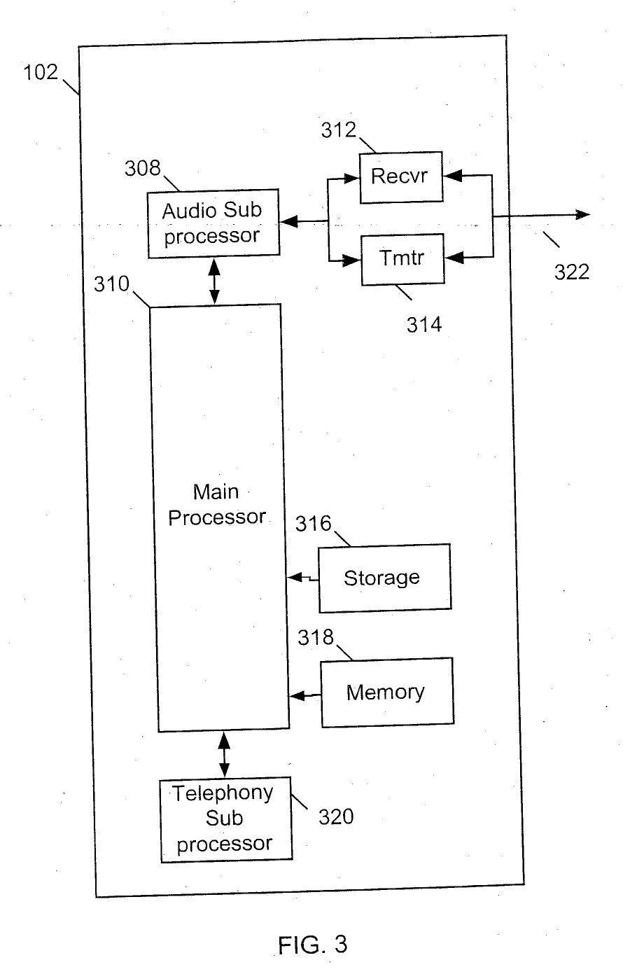

FIG. 3 is a block diagram illustrating more detail of a call management system (such as CMS 102) in one embodiment of the present invention. The CMS 102 includes a receiver 312 and a transmitter 314 for sending and receiving information over a telephone line 322 that is connected to the telephone communications network 104. All information sent or received via the receiver 312 and transmitter 314 is processed by an audio sub-processor 308.

The CMS 102 shows a main processor 310 that handles a majority of the processes associated with the call routing, call rating, call setup, call maintenance processes of the CMS 102. The CMS 102 also shows a telephony sub-processor 320 that handles processes associated with the call setup and call maintenance processes of the CMS 102.

FIG. 3 shows a storage module 316 for storing information such as rate tables, databases, and more, which are used during the overall call process. Rate tables, databases, and the like are described in greater detail below. FIG. 3 also shows a main memory module 318, such as a volatile memory element like a DRAM module. The main memory module 318 is used for storing and retrieving data and instructions necessary for performing the functions of CMS 102.

II. The First Embodiment

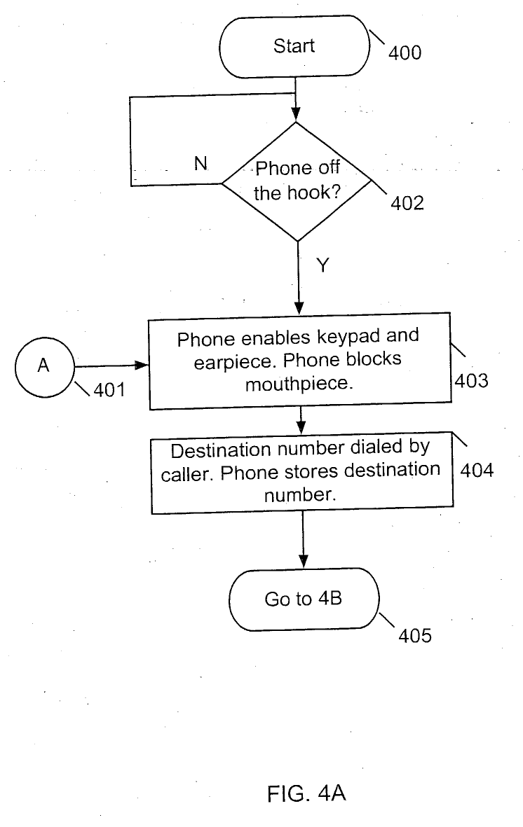

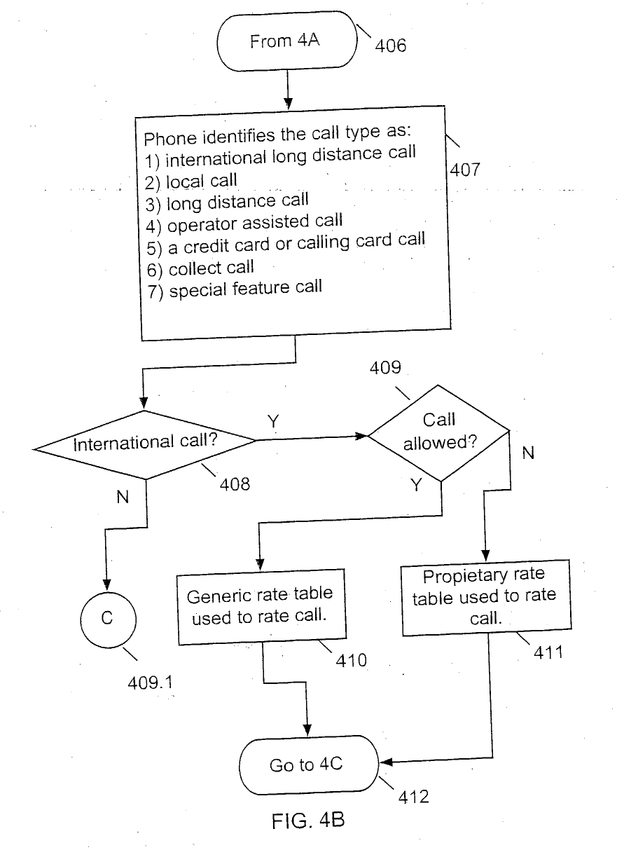

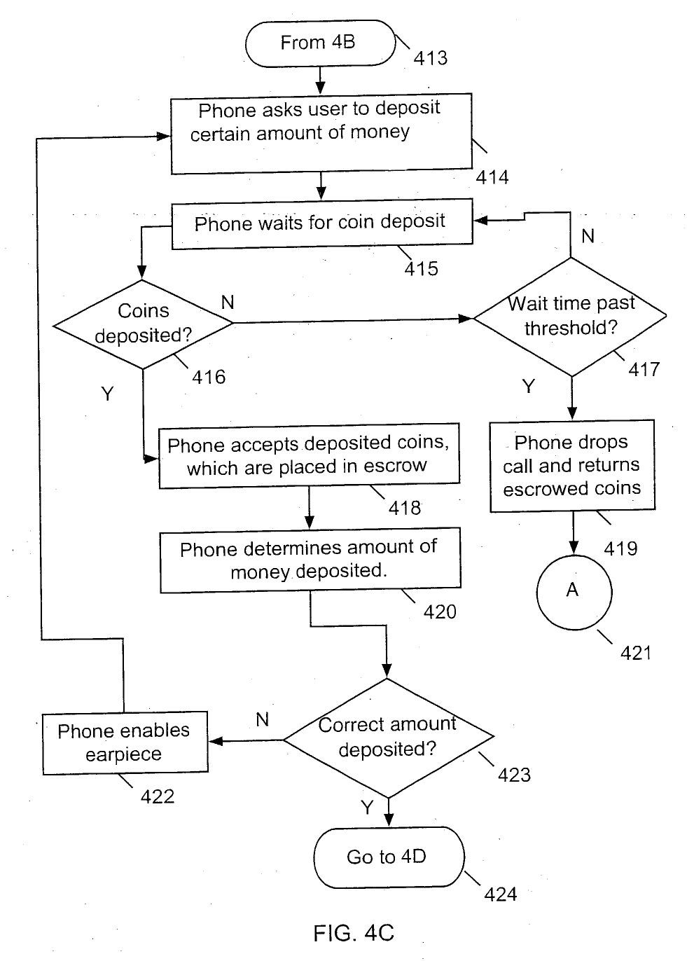

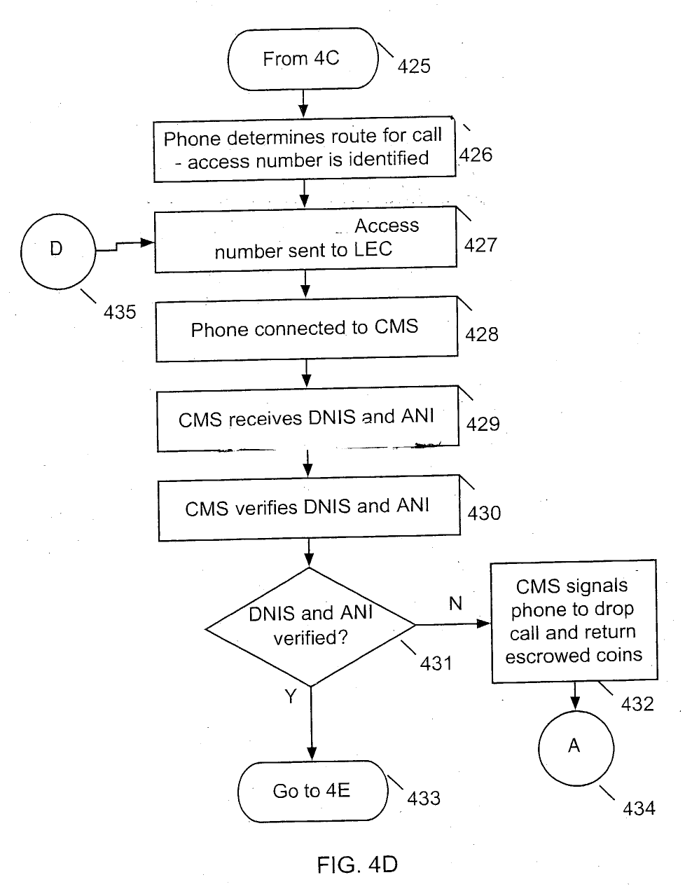

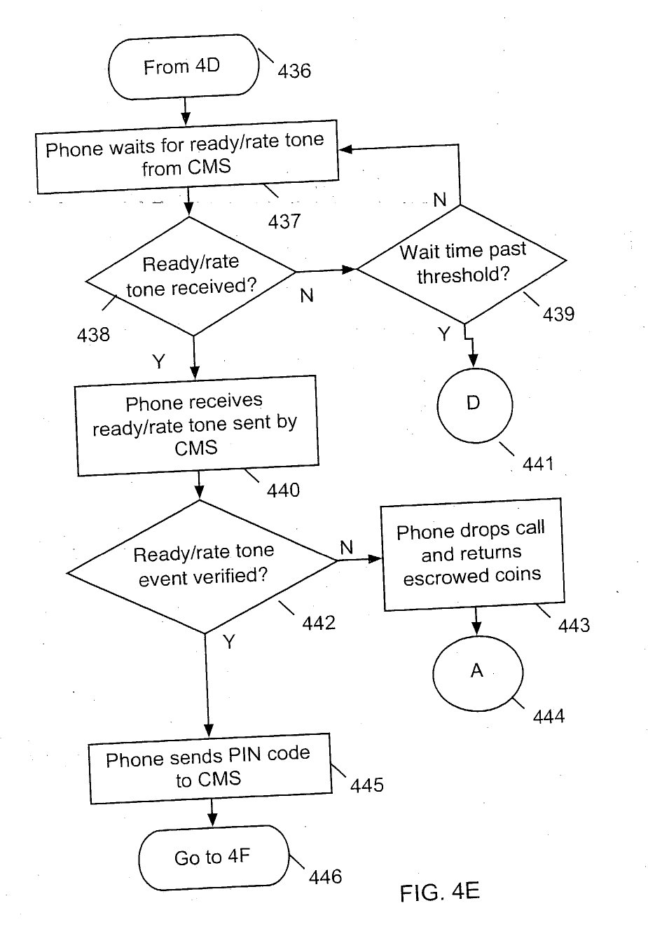

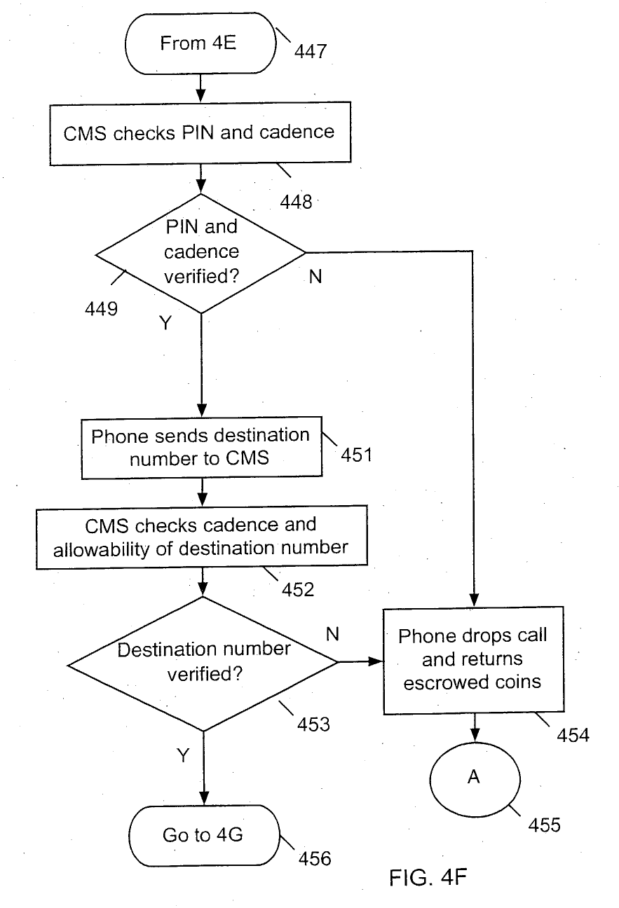

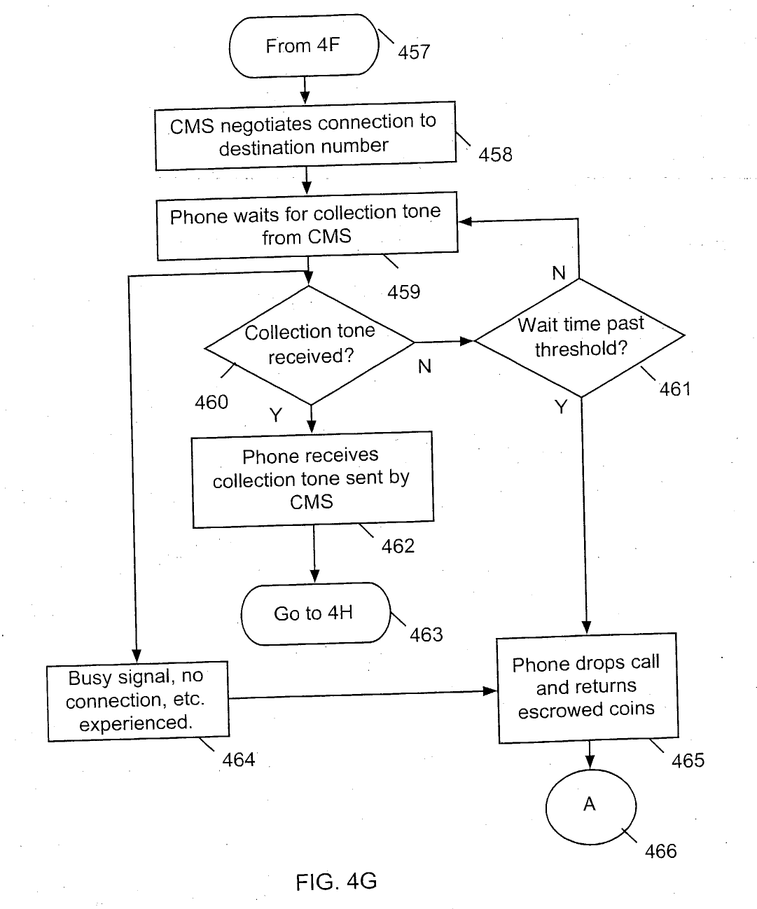

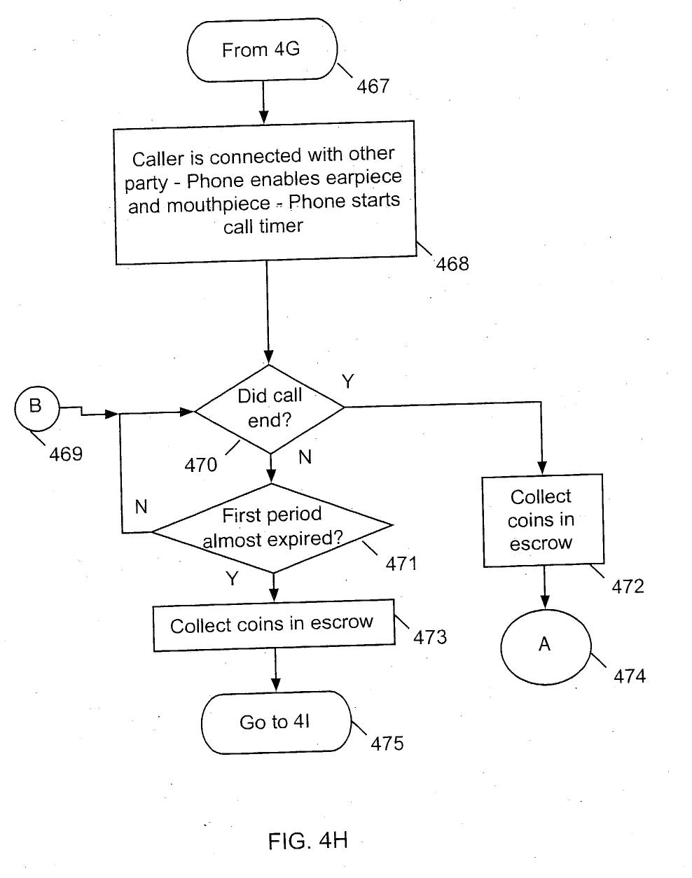

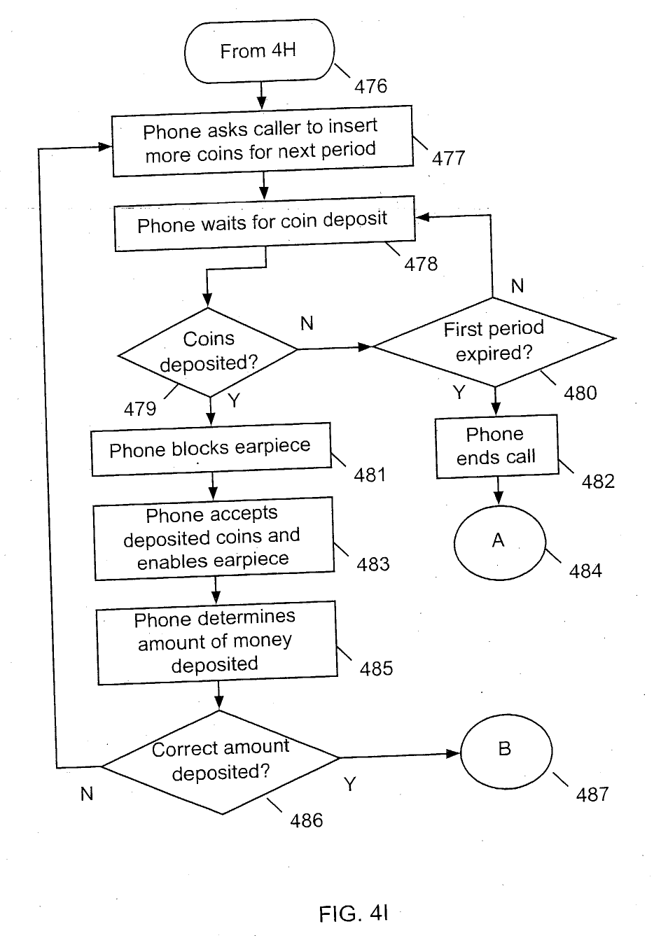

FIGS. 4A-4I are an operational flow diagram showing the overall call process according to a first embodiment of the present invention. The telephone call process of FIGS. 4A-4I is divided into the following phases: call setup phase, call rating phase, coin deposit phase, call routing phase, verification phase,, connection phase and call-in-progress phase. The aforementioned phases of the telephone call process of FIGS. 4A-4I are described with greater detail below.

FIG. 4A is an operational flow diagram showing the telephone call setup phase of the telephone call process. The call setup phase places the pay telephone 110 into a disposition such that it is prepared to initiate a telephone connection with a receiving telephone 112. The operational flow diagram of FIG. 4A begins with step 400 and flows directly to step 402.

In step 402, it is determined whether the handset 203 of the pay telephone 110 is off the hook. A handset 203 is on the hook if the handset 203 is placed in its proper receptacle on the pay telephone 110. A handset 203 is of the hook if the handset 203 is not placed in the receptacle on the pay telephone 110 and is in use by an individual. If the handset 203 is off the hook, then control flows to step 403. If the handset 203 is on the hook, then control flows back to step 402.

In step 403, the pay telephone 110 enables the keypad interface 206 and the earpiece 202 of the handset 203. This allows the user to utilize the keypad interface 206 to input a destination number and for the user to hear the input of the numbers in the earpiece 202. Also in step 403, the pay telephone 110 disables the mouthpiece 204. This is a mechanism that prevents the entrance of data or other information into the pay telephone 110 via the mouthpiece 204 during the sensitive phases of the call process prior to the establishment of a telephone call connection.

In step 404, the user dials a destination number into the keypad interface 206. The destination number is the telephone number to which the user desires to be connected. The different types of telephone numbers are described in greater detail below. Also in step 404, the pay telephone 110 stores the destination number. Typically, the destination number is stored in the storage 216 or the memory 218 of the pay telephone 110. The destination number is retrieved later during the call process.

Step 401, or bridge “A,” flows directly to step 403. In step 405, control flows directly to FIG. 4B.

FIG. 4B is an operational flow diagram showing the telephone call rating phase of the telephone call process. The call rating phase is performed by the pay telephone 110 in order to rate the cost of the desired telephone connection with a receiving telephone 112. The operational flow diagram of FIG. 4B begins with step 406 and flows directly to step 407.

In step 407, the pay telephone 110 identifies the call type based on the destination number that was stored in step 404 above. There are several call types, described as follows:

1) an international long distance call, typically consisting of a dialed “011” (if dialed from the United States, for example), followed by a country code, a city code and a telephone number

2) a local call, typically consisting of a 7-digit number or a 10-digit number (area code plus 7-digit number)

3) a long distance call, typically consisting of a dialed “1” followed by a 10-digit number (area code plus 7-digit number)

4) an operator assisted call, typically consisting of a dialed “0” or “00”

5) a credit card or calling card call, typically consisting of a dialed “0” followed by a sequence of numbers used for reaching a call provider

6) a collect call, typically consisting of a dialed “0” followed by a sequence of steps used for reaching a collect call provider

7) a special feature call, typically consisting of a dialed “911,” “411,” or a “211”

In step 407, the pay telephone 110 identifies the proper call type using a lookup table or other reference that describes the format of the various call types. In step 408, it is determined whether the call type of the destination number dialed by the user in step 404 is an international number. If the call type of the destination number dialed by the user in step 404 is an international number, then control flows to step 409. If the call type of the destination number dialed by the user in step 404 is not an international number, then control flows to step 409.1.

In 409, the pay telephone 110 determines whether the destination number dialed by the user in step 404 is allowed. This is because the pay telephone 110 may only allow international calls to certain countries or because certain destination numbers are blocked by the pay telephone 110. If the destination number dialed by the user in step 404 is allowed, then control flows to step 410. If the destination number dialed by the user in step 404 is not allowed, then control flows to step 411.

In step 410, a generic rate table, i.e., a rate table provided to the pay telephone 110 separate from the entity providing the CMS 102, is used to rate the telephone call. A rate table is a table or any other data structure that shows a correspondence between rates and various destinations, such as a country. A rate typically states a certain amount of money per minute or minutes, such as “10 cents per minute.” Preferably, rates are expressed as a number of minutes per one U.S. dollar, such as “1 dollar for five minutes.” In step 411, a proprietary rate table, i.e., a rate table provided to the pay telephone 110 by the same entity providing the CMS 102, is used to rate the telephone call.

In step 409.1, or bridge “C,” the call process is directed to the processing of all call types other than international long distance telephone calls. This is not described in greater detail. Note that the present invention is involved with the handling of rated international long distance telephone calls. Thus, the specification of the present invention focuses on describing a method for handling call type 1) (international long distance). In step 412, the control flows directly to FIG. 4C.

FIG. 4C is an operational flow diagram showing the coin deposit phase of the telephone call process. The coin deposit phase is performed by the pay telephone 110 in order to request and receive the proper coin deposit for the rated international long distance telephone call. The operational flow diagram of FIG. 4C begins with step 413 and flows directly to step 414.

In step 414, the pay telephone 110 plays a message for the user asking him to deposit a certain amount of coins corresponding to the rate determined above for a certain period of time (the first telephone call period), such as “1 dollar for five minutes.” In step 415, the pay telephone 110 waits for the deposit of the appropriate number of coins into the coin to slot/detector 205. In step 416, it is determined whether coins have been deposited into the coin slot/detector 205. If coins have been deposited into the coin slot/detector 205, then control flows to step 418. If coins have not been deposited into the coin slot/detector 205, then control flows to step 417.

In step 417, it is determined whether a threshold of time has passed since the phone 15 began waiting for a coin deposit in step 415. If a threshold of time has passed since the phone began waiting for a coin deposit in step 415, then control flows to step 419. If a threshold of time has not yet passed since the phone began waiting for a coin deposit in step 415, then control flows back to step 415.

In step 419, the pay telephone 110 drops the telephone call process and returns any 20 coins in escrow. Control flows directly to step 421, or bridge “A,” which flows directly to step 401 of FIG. 4A.

In step 418, the pay telephone 110 accepts the coins deposited via the coin slot/detector 205. These coins are placed in escrow, which is a location in the pay telephone 110 in which coins may be returned at a later time. In step 420, the pay telephone 110 determines the amount of money that was deposited in the pay telephone 110 via the coin slot/detector 205. This can be accomplished by the coin slot/detector 205 or the processor 210 of the pay telephone 110.

In step 423, the pay telephone 110 compares the amount of money deposited in the coin slot/detector 205 in step 418 with the rate of the telephone call, as determined in steps 410 or 411. If the correct amount of money was deposited for the first telephone call period according to the determined rate, then control flow to step 424. If an incorrect amount of money was deposited for the first telephone call period, then control flow to step 422. In step 422, the pay telephone 110 enables the earpiece 202 of the handset 203 of the pay telephone 110, such the user can hear the upcoming message of step 414 through the earpiece 202. In step 424, control flow directly to FIG. 4D.

FIG. 4D is an operational flow diagram showing the call routing phase of the telephone call process. The call routing phase is performed by the pay telephone 110 in order to reach the CMS 102. The operational flow diagram of FIG. 4D begins with step 425 and flows directly to step 426.

In step 426, the pay telephone 110 determines the route for the telephone call based on the destination number input in step 404. The pay telephone 110 identifies an access number for connecting to the CMS 102. In step 427, the earpiece 202 of the pay telephone 110 is enabled. Also, the access number identified in step 426 is sent to the LEC or the CO 106. Subsequently, the CO 106 negotiates a connection between the pay telephone 110 and the CMS 102 via the telephone communications network 104.

In step 429, the CMS 102 receives a Dialed Number Identification Service (DNIS) number and an Automatic Number Identification (ANI) number. The DNIS number corresponds to the access number that was sent by the pay telephone 110 in step 427. The ANI number corresponds to the telephone number of the pay telephone 110. In step 430, the CMS 102 verifies the received DNIS and ANI numbers. The CMS 102 accomplished this task by checking a lookup table, database or other data structure having a list of DNIS and ANI numbers. The CMS 102 determines whether the DNIS and ANI number combination received is present in the data structure. The purpose behind this step is to eliminate fraud upon the CMS 102.

If the CMS 102 verifies the DNIS and ANI numbers received in step 429, then control flows to step 433. If the CMS 102 does not verify the DNIS and ANI numbers received in step 429, then control flows to step 432.

In step 432, the CMS 102 sends a message to the pay telephone 110 ordering it to drop the telephone call process and return any coins in escrow. The pay telephone 110 performs as ordered. Control flows directly to step 434, or bridge “A,” which flows directly to step 401 of FIG. 4A. Step 435, or bridge “D,” flows directly to step 427. In step 433, control flows directly to FIG. 4E.

FIG. 4E is an operational flow diagram showing a first half of the verification phase of the telephone call process. The verification phase is performed by the pay telephone 110 and the CMS 102 in order to insure that both parties are adhering to established protocol. This helps to eliminate fraud and insure solid communication between the two parties. The operational flow diagram of FIG. 4E begins with step 436 and flows directly to step 437.

In step 437, the pay telephone 110 waits for a ready/rate tone event from the CMS 102. A ready/rate tone event is a DTMF tone (sent by the CMS 102 and received by the pay telephone 110) that corresponds to a particular rate table. The ready/rate tone is used to confirm that the CMS 102 and the pay telephone 110 are both using the same rate table. The ready/rate tone also indicates that the CMS 102 is prepared to continue with the initiation of the telephone call. In step 438, it is determined whether a ready/rate tone event has been received. If a ready/rate tone event has been received, the control flows to step 440. If a ready/rate tone event has not been received, then control flows to step 439.

In step 439, it is determined whether a threshold of time has passed since the phone began waiting for a ready/rate tone in step 437. If a threshold of time has passed since the phone began waiting, then control flows to step 441. If a threshold of time has not yet passed since the phone began waiting, then control flows back to step 437. In step 441, or bridge “D,” control flows back to step 427 of FIG. 4D where the pay telephone 110 attempts to reconnect to the CMS 102.

In step 440, the pay telephone 110 receives the ready/rate tone sent by the CMS 102. In step 442, the ready/rate tone is checked for confirmation. This consists of determining whether the correct DTMF tone was received. The pay telephone 110 accesses a table or other predefined data structure that describes a correspondence between DTMF tones and rate tables. The information in the data structure is then used to compare the expected DTMF tone with the received DTMF tone. The two DTMF tones must match.

In addition to confirming the correct tone, the pay telephone 110 confirms that a predetermined amount of silence was played before and after the ready/rate tone was played. Finally, the pay telephone 110 confirms that the duration and volume of the ready/rate tone event of step 438 adheres to established parameters. If all of the above factors are confirmed to be true by the pay telephone 110, then control flows to step 445. If all of the above factors are not confirmed to be true by the pay telephone 110, then control flows to step 443.

In step 443, the pay telephone 110 drops the telephone call process and returns any coins in escrow. Control flows directly to step 444, or bridge “A,” which flows directly to step 401 of FIG. 4A.

In step 445, the pay telephone 110 sends an authorization code, or a Personal Identification Number (PIN) to the CMS 102. Preferably, the authorization code comprises five DTMF tones—four dialed numbers followed by a pound sign. In step 446, control flows directly to FIG. 4F.

FIG. 4F is an operational flow diagram showing the second half of the verification phase of the telephone call process. The verification phase is performed by the pay telephone 110 and the CMS 102 in order to insure that both parties are adhering to established protocol. This helps to eliminate fraud and insure solid communication between the two parties. The operational flow diagram of FIG. 4F begins with step 447 and flows directly to step 448.

In step 449, the authorization code is checked by the CMS 102 for confirmation. This consists of determining whether the correct authorization code was received. The CMS 102 accesses a table or other predefined data structure that describes a correspondence between each pay telephone 110 (identified by its ANI previously) and an authorization code. The information in the data structure is then used to compare the expected authorization code with the received authorization code. The two authorization codes must match.

In addition to confirming the correct authorization code, the CMS 102 confirms that a predetermined amount of silence was played before and after the authorization code was played. Finally, the CMS 102 confirms that the cadence of the authorization code received adheres to established parameters. If all of the above factors are confirmed to be true by the CMS 102, then control flows to step 451. If all of the above factors are not confirmed to be true by the CMS 102, then control flows to step 454.

In step 454, the CMS orders the pay telephone 110 to drop the telephone call process and return any coins in escrow. The pay telephone 110 performs as ordered. Control flows directly to step 455, or bridge “A,” which flows directly to step 401 of FIG. 4A.

In step 451, the pay telephone 110 sends the destination number to the CMS 102 in DTMF tones. Preferably, the pay telephone 110 sends the destination number to the CMS 102 in DTMF tones followed by a pound sign.

In step 452, the CMS 452 verifies that the cadence of the destination number received adheres to established parameters. Also in step 452, the CMS 452 verifies that the destination number is allowed for a telephone connection. This is accomplished by accessing a list, a database or other data structure to determine whether the destination number is present in the data structure. The data structure, for example, may hold a list of destination numbers or simply a country code indicating a set of destination umbers that are not serviced by the CMS 102. If all of the above factors are confirmed to be true by the CMS 102, then control flows to step 456. If all of the above factors are not confirmed to be true by the CMS 102, then control flows to step 454.

In step 456, control flows directly to FIG. 4G.

FIG. 4G is an operational flow diagram showing the connection phase of the telephone call process. The connection phase is performed by the pay telephone 110 and the CMS 102 in order to establish a telephone call connection between the calling party 110 and the receiving party 112. The operational flow diagram of FIG. 4G begins with step 457 and flows directly to step 458.

In step 458, the CMS 102 negotiates a connection to the destination number, i.e., telephone 112, via the telephone network 104 and the central office 108. Recall that a connection was already established between the pay telephone 110 and the CMS 102 via the telephone network 104 and the central office 106. In step 459, the pay telephone 110 waits for a collection tone from the CMS 102. A collection tone is preferably a DTMF tone played by the CMS 102 that indicates to the pay telephone 110 that the telephone call has commenced. The pay telephone 110 waits and listens for a particular DTMF that indicates a collection tone. If the correct DTMF tone is not played by the CMS 102, the pay telephone 110 does not hear a collection tone.

In step 460, it is determined whether a collection tone has been received. If a collection tone has been received, then control flows to step 462. If a collection tone has not been received, then control flows to step 461.

In step 461, it is determined whether a threshold of time has passed since the phone began waiting for a collection tone in step 459. If a threshold of time has passed since the phone began waiting for a collection tone, then control flows to step 465. If a threshold of time has not yet passed since the phone began waiting for a collection tone, then control flows back to step 459.

Alternative to receiving a collection tone, in step 464, the pay telephone 110 may receive a busy signal, prerecorded operator message or any other signal indicating that a telephone call connection could not be made. In step 465, the pay telephone 110 drops the telephone call process and returns any coins in escrow. Control flows directly to step 466, or bridge “A,” which flows directly to step 401 of FIG. 4A.

In step 462, the pay telephone 110 receives the collection tone sent by the CMS 102. In step 463, the control flows directly to FIG. 4H.

FIG. 4H is an operational flow diagram showing the first half of the call-in-progress phase of the telephone call process. The call-in-progress phase is performed by the pay telephone 110 and the CMS 102 and encompasses the tasks performed during a telephone call connection between the calling party 110 and the receiving party 112. The operational flow diagram of FIG. 4H begins with step 467 and flows directly to step 468.

In step 468, the caller—pay telephone 110—is connected with the receiving party—the telephone 112. Subsequently, the pay telephone 110 enables the earpiece 202 and the mouthpiece 204 so that the user may hear the call and speak into the mouthpiece 204. Also, the pay telephone 110 starts a call timer to keep track of the first telephone call period.

In step 470, it is determined whether the call has ended due to either of the parties, a bad connection, and more For example, any of the two parties may have hung up their respective telephone or the connection may have been dropped by the telephone communication system 104 due to heavy traffic. If the call has ended, then control flows to step 472. If the call has not ended, the control flows to step 471. Note that at any time during the call process of FIGS. 4A-41, the user of pay telephone 110 can end the call process, placing the control flow at step 472.

In step 472, the pay telephone 110 collects any coins in escrow for the first telephone call period. Control flows directly to step 474, or bridge “A,” which flows directly to step 401 of FIG. 4A.

In step 471, it is determined by the pay telephone 110 whether the first telephone call period has almost expired. That is, it is determined whether the call timer of pay telephone 110 has reached a predetermined moment in time before the end of the first telephone call period, such as 35-40 before the end of the first telephone call period. If the result of the determination of step 471 is positive, then control flows to step 473. If the result of the determination of step 471 is negative, then control flows back to step 470.

In step 473, the pay telephone 110 collects the coins in escrow. Alternative, to step 473, the pay telephone 110 can be programmed to collect the coins in escrow after a grace period extending past the end of the first telephone call period. In this alternative, the collection of the coins in escrow of step 473 would occur at some time after the end of the first telephone call period, such as after step 480 of FIG. 41.

Step 469, or bridge “B,” flows directly to step 470. In step 475, control flows directly to FIG. 4I.

FIG. 4I is an operational flow diagram showing the second half of the call-in-progress phase of the telephone call process. The call-in-progress phase is performed by the pay telephone 110 and the CMS 102 and encompasses the tasks performed during a telephone call connection between the calling party 110 and the receiving party 112. The operational flow diagram of FIG. 4I begins with step 476 and flows directly to step 477.

In step 477, the pay telephone 110 plays a message through the earpiece 202 of the handset 203 notifying the user that the first telephone call period is about to expire and asking the user to insert additional coins for the next telephone call period. In step 478, the pay telephone 110 waits for the deposit of the appropriate number of coins into the coin slot/detector 205. In step 479, it is determined whether coins have been deposited into the coin slot/detector 205. If coins have been deposited into the coin slot/detector 205, then control flows to step 481. If coins have not been deposited into the coin slot/detector 205, then control flows to step 480.

In step 480, it is determined whether the first telephone call period has expired since the phone began waiting for a coin deposit in step. 478. If the first telephone call period has expired since the phone began waiting for a coin deposit, then control flows to step 482. If the first telephone call period has not expired since the phone began waiting for a coin deposit, then control flows back to step 478.

In step 482, the pay telephone 110 drops the telephone call process. Control flows directly to step 484, or bridge “A,” which flows directly to step 401 of FIG. 4A.

In step 481, the pay telephone 110 disables the earpiece 202 of the handset 203 of the pay telephone 110. In step 483, the pay telephone 110 accepts the coins deposited via the coin slot/detector 205. These coins are placed in escrow, which is a location in the pay telephone 110 in which coins may be returned at a later time. In step 485, the pay telephone 110 determines the amount of money that was deposited in the pay telephone 110 via the coin slot/detector 205. This can be accomplished by the coin slot/detector 205 or the processor 210 of the pay telephone 110. Also, in step 483, the pay telephone 110 enables the earpiece 202 of the handset 203.

In step 486, the pay telephone 110 compares the amount of money deposited in the coin, slot/detector 205 in step 483 with the rate of the next telephone call period, as determined in steps 410 or 411 above. If the correct amount of money was deposited for the next telephone call period according to the determined rate, then control flows to step 487, or bridge “B.” If an incorrect amount of money was deposited for the next telephone call period, then control flows back to step 477.

m. The Second Embodiment

The second embodiment of the present invention is similar to the first embodiment of the present invention. That is, the overall call process of the first embodiment is similar to the overall call process of the second embodiment. The difference between the two call processes is that in the second embodiment, the overall call process allows for the CMS 102 to control the rating of any telephone call periods subsequent to the first telephone call period. This difference is seen in the call-in-progress phase of the telephone call process.

The telephone call process of the second embodiment is divided into the following phases: call setup phase, call rating phase, coin deposit phase, call routing phase, verification phase, connection phase and call-in-progress phase. Only the call-in-progress phase of the second embodiment differs from the first embodiment. Therefore, the call setup phase, call rating phase, coin deposit phase, call routing phase, verification phase and connection phase of the first embodiment (embodied in FIGS. 4A-4G) are utilized to describe the second embodiment. The call-in-progress phase of the second embodiment is described in greater detail below.

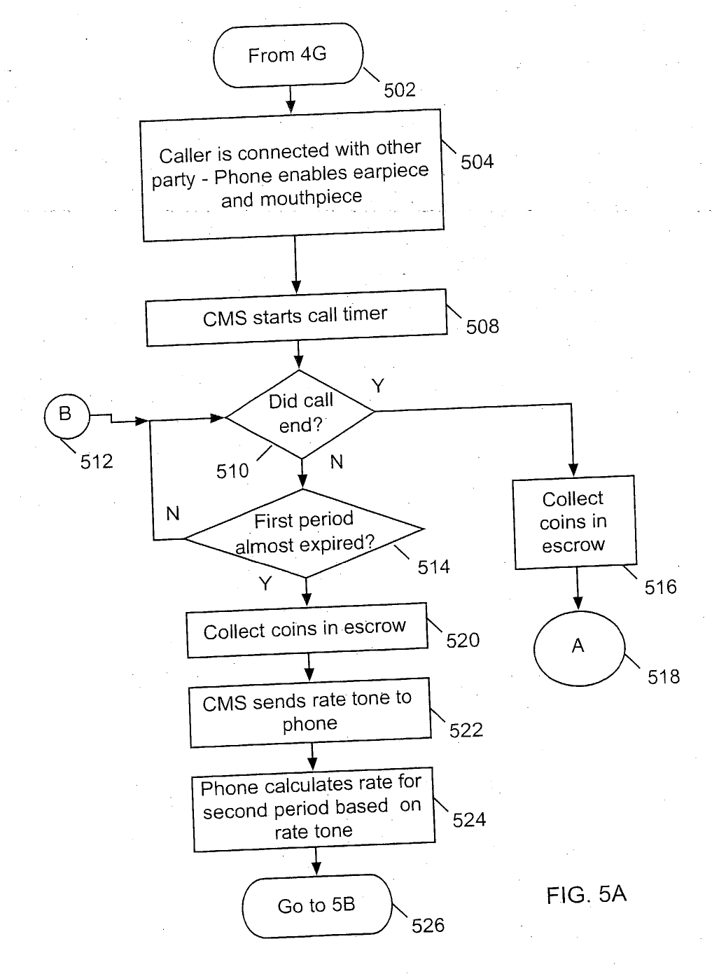

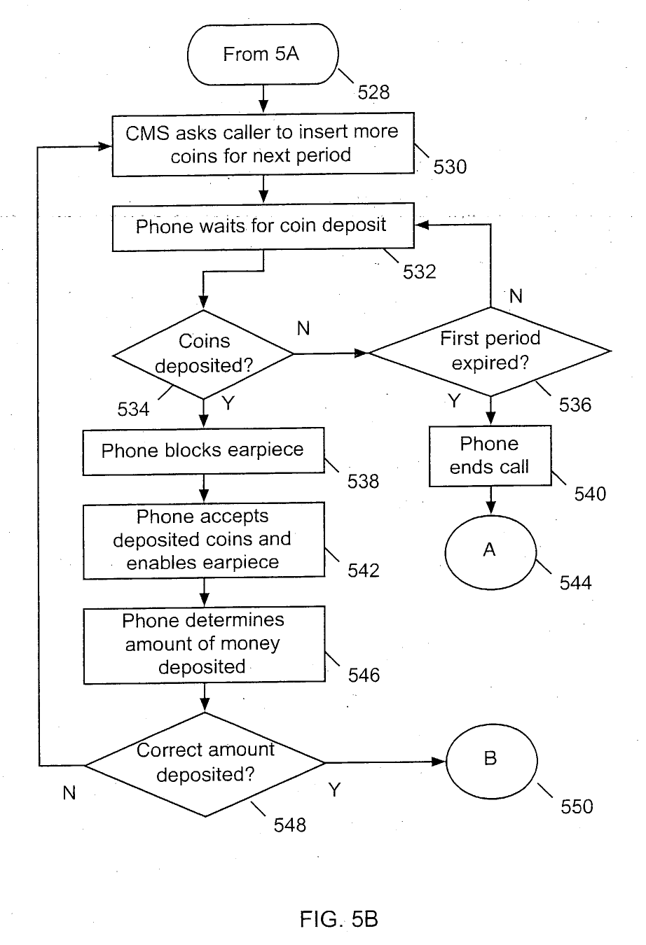

FIGS. 5A-5B are an operational flow diagram showing the call-in-progress process according to a second embodiment of the present invention. FIG. 5A is an operational flow diagram showing the first half of the call-in-progress phase of the telephone call process. The call-in-progress phase is performed by the pay telephone 110 and the CMS 102 and encompasses the tasks performed during a telephone call connection between the calling party 110 and the receiving party 112. The operational flow diagram of FIG. 5A begins with step 502 and flows directly to step 504.

In step 504, the caller—pay telephone 110—is connected with the receiving party—the telephone 112. Subsequently, the pay telephone 110 enables the earpiece 202 and the mouthpiece 204 so that the user may hear the call and speak into the mouthpiece 204. In step 508, the CMS 102 starts a call timer to keep track of the first telephone call period.

In step 510, it is determined whether the call has ended due to either of the parties, a bad connection, and more For example, any of the two parties may have hung up their respective telephone or the connection may have been dropped by the telephone communication system 104 due to heavy traffic. If the call has ended, then control flows to step 516. If the call has not ended, the control flows to step 514. Note that at any time during the call process of the second embodiment, the user of pay telephone 110 can end the call process, placing the control flow at step 516.

In step 516, the pay telephone 110 collects any coins in escrow for the first telephone call period. Control flows directly to step 474, or bridge “A,” which flows directly to step 401 of FIG. 4A.

In step 514, it is determined by the CMS 102 whether the first telephone call period has almost expired. That is, it is determined whether the call timer of CMS 102 has reached a predetermined moment in time before the end of the first telephone call period, such as 35-40 before the end of the first telephone call period. If the result of the determination of step 514 is positive, then control flows to step 520. If the result of the determination of step 514 is negative, then control flows back to step 510.

In step 516, the pay telephone 110 collects the coins in escrow. Alternative, to step 516, the pay telephone 110 can be programmed to collect the coins in escrow after a grace period extending past the end of the first telephone call period. In this alternative, the collection of the coins in escrow of step 520 would occur at some time after the end of the first telephone call period, such as after step 536 of FIG. 5B.

In step 522, the CMS 102 sends a rate tone to the pay telephone 110. Preferably the rate tone is a DTMF tone corresponding to a rate. In step 524, the pay telephone 110 calculates a rate for the next telephone call period based on the received rate tone. This is accomplished by accessing a table, database or other data structure describing a correspondence between DTMF tones and telephone call rates.

Step 512, or bridge “B,” flows directly to step 510. In step 526, control flows directly to FIG. 5B.

FIG. 5B is an operational flow diagram showing the second half of the call-in-progress phase of the telephone call process. The call-in-progress phase is performed by the pay telephone 110 and the CMS 102 and encompasses the tasks performed during a telephone call connection between the calling party 110 and the receiving party 112. The operational flow diagram of FIG. 5B begins with step 528 and flows directly to step 530.

In step 530, the CMS 102 plays a message notifying the user that the first telephone call period is about to expire and asking the user to insert additional coins for the next telephone call period. In step 532, the pay telephone 110 waits for the deposit of the appropriate number of coins into the coin slot/detector 205. In step 534, it is determined whether coins have been deposited into the coin slot/detector 205. If coins have been deposited into the coin slot/detector 205, then control flows to step 538. If coins have not been deposited into the coin slot/detector 205, then control flows to step 536.

In step 536, it is determined whether the first telephone call period has expired since the phone began waiting for a coin deposit in step 532. If the first telephone call period has expired since the phone began waiting for a coin deposit, then control flows to step 540. If the first telephone call period has not expired since the phone began waiting for a coin deposit, then control flows back to step 532.

In step 540, the pay telephone 110 drops the telephone call process. Control flows directly to step 544, or bridge “A,” which flows directly to step 401 of FIG. 4A.

In step 538, the pay telephone 110 disables the earpiece 202 of the handset 203 of the pay telephone 110. In step 542, the pay telephone 110 accepts the coins deposited via the coin slot/detector 205. These coins are placed in escrow, which is a location in the pay telephone 110 in which coins may be returned at a later time. Also, in step 542, the pay telephone 110 enables the earpiece 202 of the handset 203. In step 546, the pay telephone 110 determines the amount of money that was deposited in the pay telephone 110 via the coin slot/detector 205. This can be accomplished by the coin slot/detector 205 or the processor 210 of the pay telephone 110.

In step 548, the pay telephone 110 compares the amount of money deposited in the coin slot/detector 205 in step 542 with the rate of the next telephone call period, as determined in step 524 above. If the correct amount of money was deposited for the next telephone call period according to the determined rate, then control flows to step 550, or bridge “B.” If an incorrect amount of money was deposited for the next telephone call period, then control flows back to step 530.

IV. The Third Embodiment

The third embodiment of the present invention is similar to the first and second embodiments of the present invention. That is, the overall call process of the third embodiment is similar to the overall call process of the first and second embodiments. The difference between the call processes is that in the third embodiment, the overall call process allows for the CMS 102 to control the rating of all telephone call periods of the pay telephone 110. This difference is seen in all phases of the telephone call process.

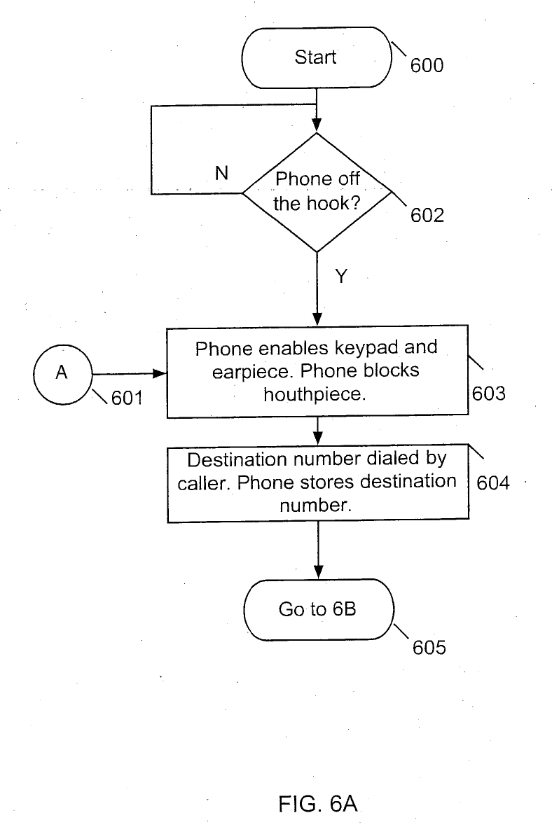

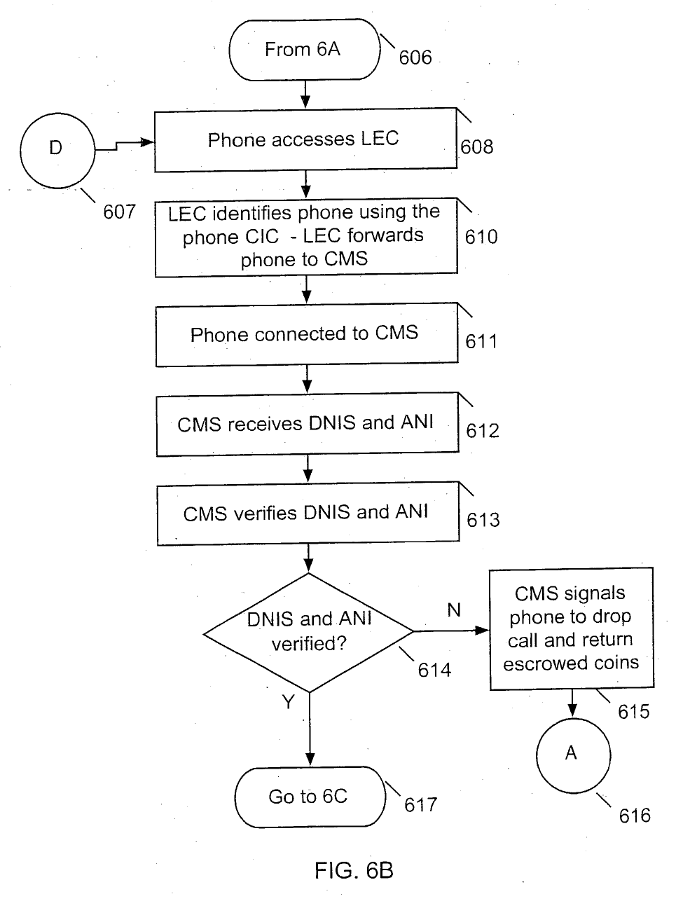

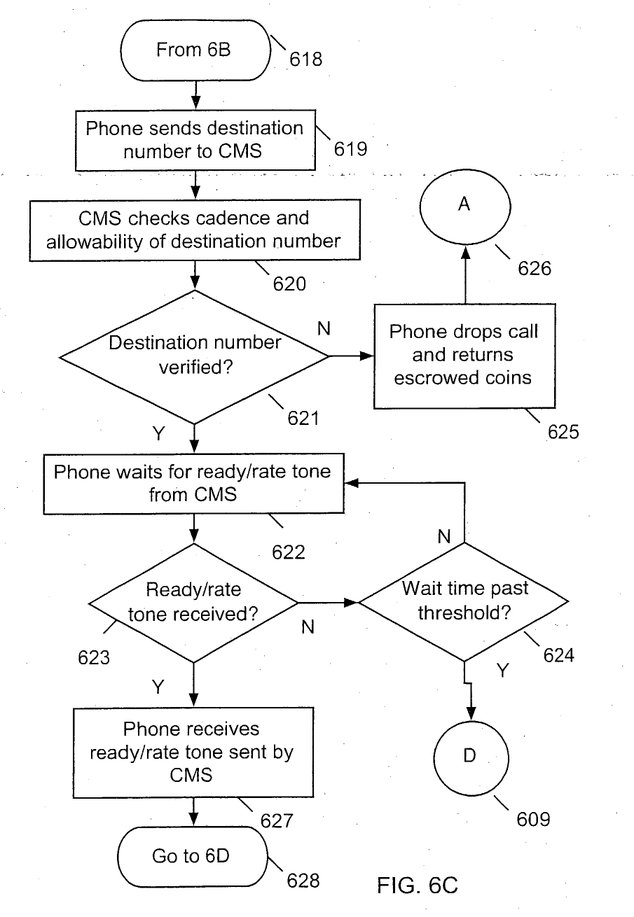

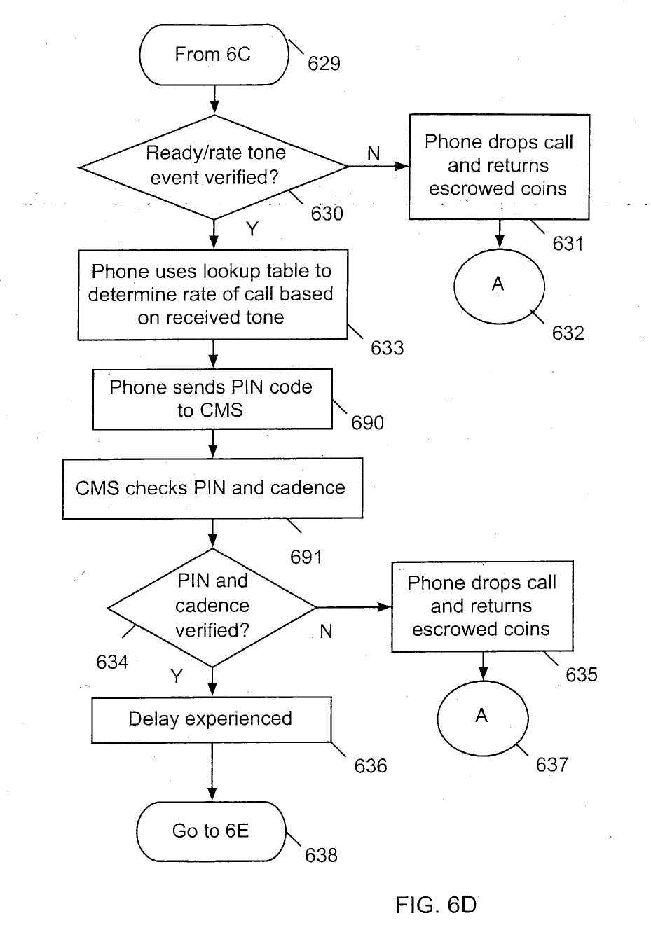

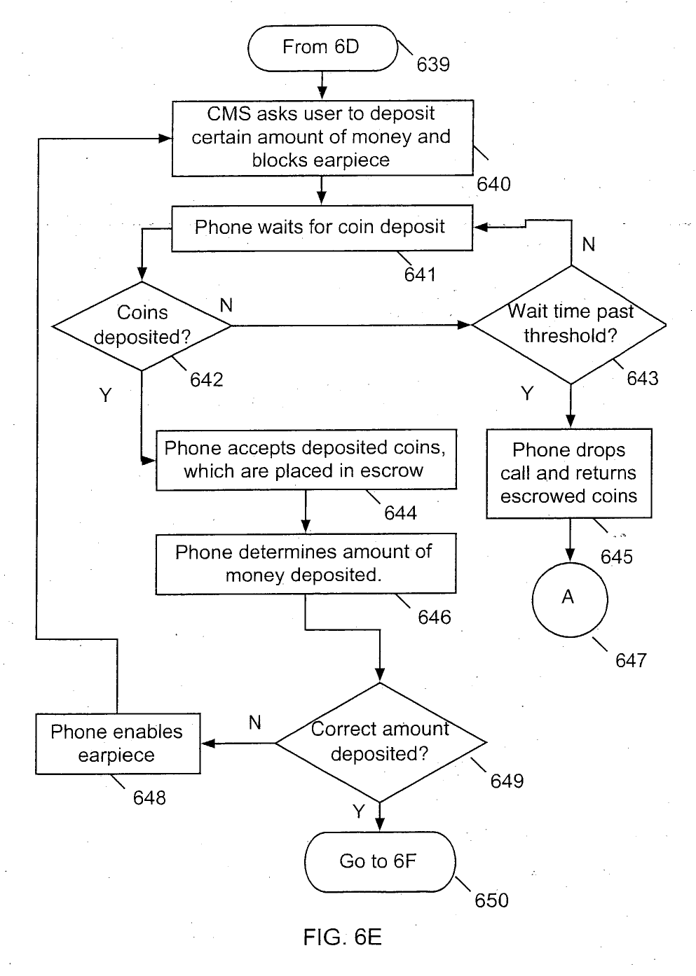

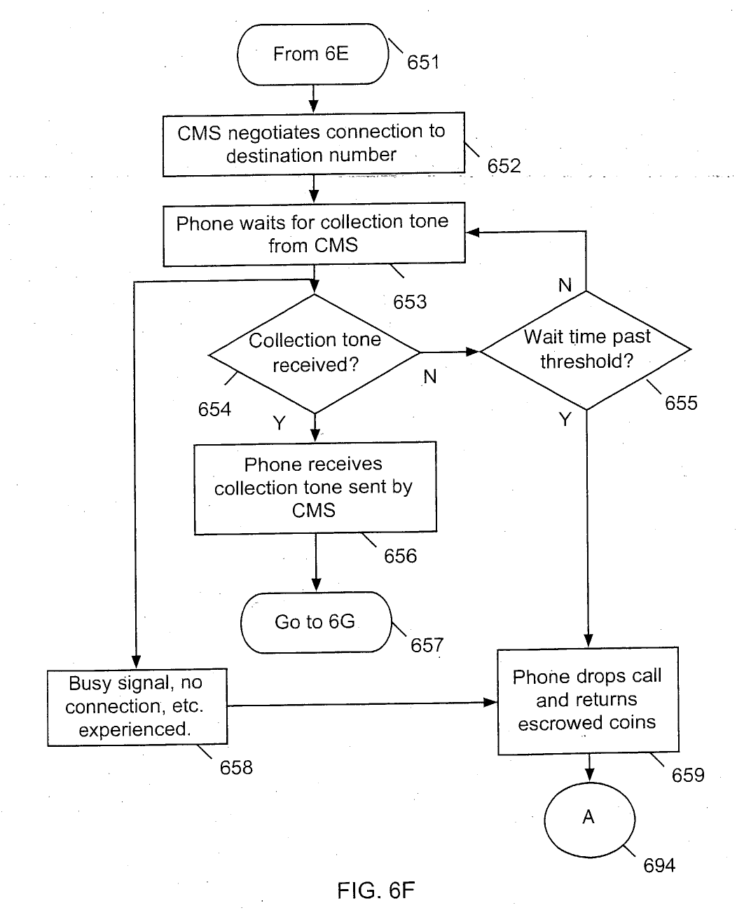

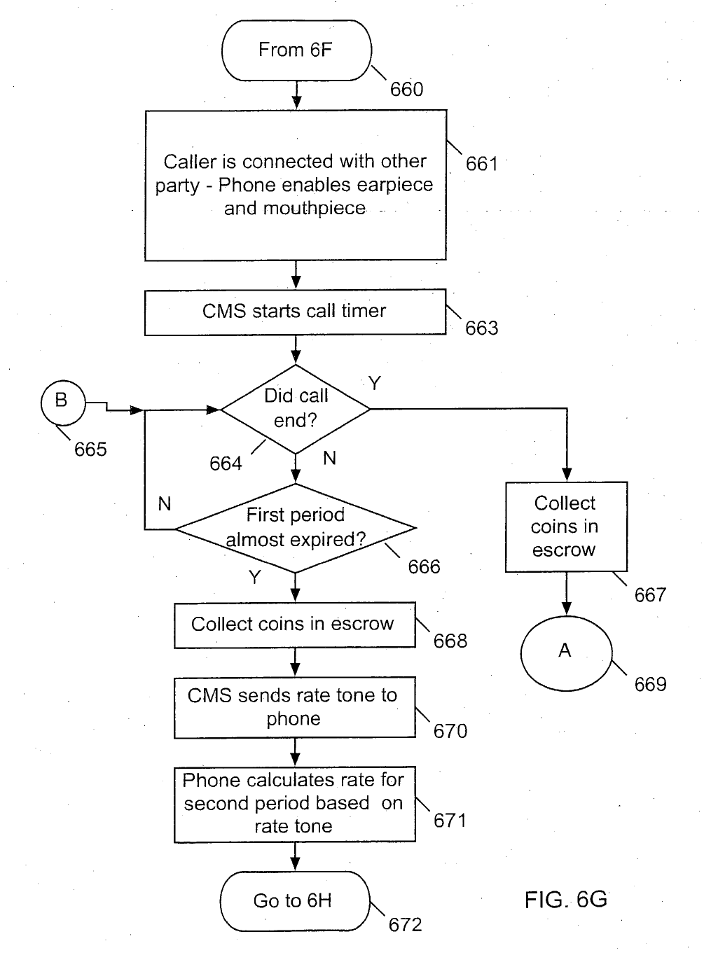

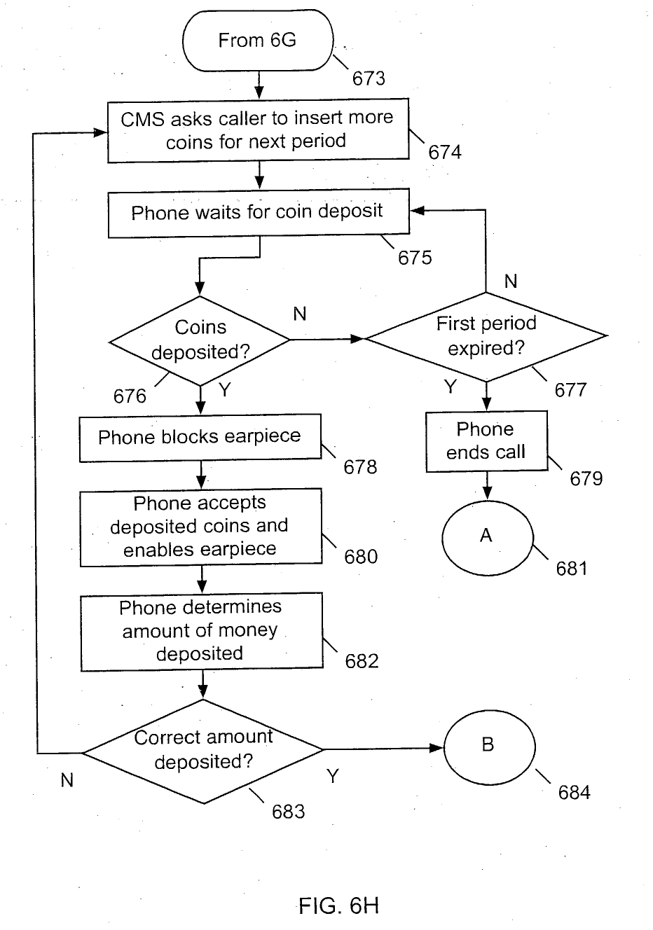

FIGS. 6A-6H are an operational flow diagram showing the overall call process according to a third embodiment of the present invention. The telephone call process of the third embodiment is divided into the following phases: call setup phase, call routing phase, verification phase, coin deposit phase, connection phase and call-in-progress phase. The aforementioned phases of the telephone call process of FIGS. 6A-6H are described with greater detail below.

FIG. 6A is an operational flow diagram showing the telephone call setup phase of the telephone call process. The call setup phase places the pay telephone 110 into a disposition such that it is prepared to initiate a telephone connection with a receiving telephone 112. The operational flow diagram of FIG. 6A begins with step 600 and flows directly to step 602.

In step 602, it is determined whether the handset 203 of the pay telephone 10 is off the hook. A handset 203 is on the hook if the handset 203 is placed in its proper receptacle on the pay telephone 110. A handset 203 is of the hook if the handset 203 is not placed in the receptacle on the pay telephone 110 and is in use by an individual. If the handset 203 is off the hook, then control flows to step 603. If the handset 203 is on the hook, then control flows back to step 602.

In step 603, the pay telephone 110 enables the keypad interface 206 and the earpiece 202 of the handset 203. This allows the user to utilize the keypad interface 206 to input a destination number and for the user to hear the input of the numbers in the earpiece 202. Also in step 603, the pay telephone 110 disables the mouthpiece 204. This is a mechanism that prevents the entrance of data or other information into the pay telephone 110 via the mouthpiece 204 during the sensitive phases of the call process prior to the establishment of a telephone call connection.

In step 604, the user dials a destination number into the keypad interface 206. The destination number is the telephone number to which the user desires to be connected. The different types of telephone numbers are described in greater detail above. Also in step 604, the pay telephone 110 stores the destination number. Typically, the destination number is stored in the storage 216 or the memory 218 of the pay telephone 110. The destination number is retrieved later during the call process.

Step 601, or bridge “A,” flows directly to step 603. In step 605, control flows directly to FIG. 6B.

FIG. 6B is an operational flow diagram showing the call routing phase of the telephone call process. The call routing phase is performed by the LEC, or CO 106, and the CMS 102. The operational flow diagram of FIG. 6B begins with step 606 and flows directly to step 608.

In step 608, the pay telephone 110 accesses the LEC, or CO 106. In step 610, the CO 106 identifies the pay telephone 110 by its Carrier Identification Code (CIC)—a unique identifier of the pay telephone 110. The CO 106 has been pre-programmed to recognize the CIC of the pay telephone 110 and to initiate a connection between the pay telephone 110 and the CMS 102. Subsequently, in step 611; the CO 106 negotiates a connection between the pay telephone 110 and the CMS 102 via the telephone communications network 104. In addition, the earpiece 202 of the pay telephone 110 is enabled.

In step 612, the CMS 102 receives a Dialed Number Identification Service (DNIS) number and an Automatic Number Identification (ANI) number. The DNIS number corresponds to the access number of the CMS 102. The ANI number corresponds to the telephone number of the pay telephone 110. In step 613, the CMS 102 verifies the received DNIS and ANI numbers. The CMS 102 accomplishes this task by checking a lookup table, database or other data structure having a list of DNIS and ANI numbers. The CMS 102 determines whether the DNIS and ANI number combination received is present in the data structure. The purpose behind this step is to eliminate fraud upon the CMS 102.

If the CMS 102 verifies the DNIS and ANI numbers received in step 614, then control flows to step 617. If the CMS 102 does not verify the DNIS and ANI numbers received in step 614, then control flows to step 615.

In step 615, the CMS 102 sends a message to the pay telephone 110 ordering it to drop the telephone call process and return any coins in escrow. The pay telephone 110 performs as ordered. Control flows directly to step 616, or bridge “A,” which flows directly to step 601 of FIG. 6A. Step 607, or bridge “D,” flows directly to step 608. In step 617, control flows directly to FIG. 6C.

FIG. 6C is an operational flow diagram showing a first half of the verification phase of the telephone call process. The verification phase is performed by the pay telephone 110 and the CMS 102 in order to insure that both parties are adhering to established protocol. This helps to eliminate fraud and insure solid communication between the two parties. The operational flow diagram of FIG. 6C begins with step 618 and flows directly to step 619.

In step 619, the pay telephone 110 sends the destination number to the CMS 102 in DTMF tones. Preferably, the pay telephone 110 sends the destination number to the CMS 102 in DTMF tones followed by a pound sign.

In step 620, the CMS 102 verifies that the cadence of the destination number received adheres to established parameters. Also in step 620, the CMS 452 verifies that the destination number is allowed for a telephone connection. This is accomplished by accessing a list, a database or other data structure to determine whether the destination number is present in the data structure. The data structure, for example, may hold a list of destination numbers or simply a country code indicating a set of destination umbers that are not serviced by the CMS 102. If all of the above factors are confirmed to be true by the CMS 102 in step 621, then control flows to step 622. If all of the above factors are not confirmed to be true by the CMS 102 in step 621, then control flows to step 625.

In step 625, the CMS orders the pay telephone 110 to drop the telephone call process and return any coins in escrow. The pay telephone 110 performs as ordered. Control flows directly to step 626, or bridge “A,” which flows directly to step 601 of FIG. 6A.

In step 622, the pay telephone 110 waits for a ready/rate tone event from the CMS 102. A ready/rate tone event is a DTMF tone (sent by the CMS 102 and received by the pay telephone 110) that corresponds to a particular rate. The ready/rate tone is used by the CMS 102 to send a rate to the pay telephone 110 for rating the telephone call. The ready/rate tone also indicates that the CMS 102 is prepared to continue with the initiation of the telephone call. In step 623, it is determined whether a ready/rate tone event has been received. If a ready/rate tone event has been received, the control flows to step 627. If a ready/rate tone event has not been received, then control flows to step 624.

In step 624, it is determined whether a threshold of time has passed since the phone began waiting for a ready/rate tone in step 622. If a threshold of time has passed since the phone began waiting, then control flows to step 609. If a threshold of time has not yet passed since the phone began waiting, then control flows back to step 622. In step 609, or bridge “D,” control flows back to step 608 of FIG. 6B where the pay telephone 110 attempts to reconnect to the CMS 102.

In step 627, the pay telephone 110 receives the ready/rate tone sent by the CMS 102. In step 628, control flows directly to FIG. 6D.

FIG. 6D is an operational flow diagram showing the second half of the verification phase of the telephone call process. The verification phase is performed by the pay telephone 110 and the CMS 102 in order to insure that both parties are adhering to established protocol. This helps to eliminate fraud and insure solid communication between the two parties. The operational flow diagram of FIG. 6D begins with step 629 and flows directly to step 630.

In step 630, the ready/rate tone is checked for confirmation. This consists of confirming that a predetermined amount of silence was played before and after the ready/rate tone was played. Also, the pay telephone 110 confirms that the duration and volume of the ready/rate tone event of step 627 adheres to established parameters. If all of the above factors are confirmed to be true by the pay telephone 110, then control flows to step 633. If all of the above factors are not confirmed to be true by the pay telephone 110, then control flows to step 631.

In step 631, the pay telephone 110 drops the telephone call process and returns any coins in escrow. Control flows directly to step 632, or bridge “A,” which flows directly to step 601 of FIG. 6A.

In step 633, the pay telephone l 10 uses a lookup table, database or any other data structure to determine the rate that corresponds, to the ready/rate (DTMF) tone received in step 627. The data structure describes a simple correspondence between DTMF tones and rates.

In step 690, the pay telephone 110 sends an authorization code, or a Personal Identification Number (PIN) to the CMS 102. Preferably, the authorization code comprises five DTMF tones—four dialed numbers followed by a pound sign.

In step 691, the authorization code is checked by the CMS 102 for confirmation. This consists of determining whether the correct authorization code was received. The CMS 102 accesses a table or other predefined data structure that describes a correspondence between each pay telephone 110 (identified by its ANI previously) and an authorization code. The information in the data structure is then used to compare the expected authorization code with the received authorization code. The two authorization codes must match.

In addition to confirming the correct authorization code, the CMS 102 confirms that a predetermined amount of silence was played before and after the authorization code was played. Finally, the CMS 102 confirms that the cadence of the authorization code received adheres to established parameters. If all of the above factors are confirmed to be true by the CMS 102, then control flows to step 638. If all of the above factors are not confirmed to be true by the CMS 102, then control flows to step 635.

In step 635, the CMS orders the pay telephone 110 to drop the telephone call process and return any coins in escrow. The pay telephone 110 performs as ordered. Control flows directly to step 637, or bridge “A,” which flows directly to step 601 of FIG. 6A. In step 638, control flows directly to FIG. 6E.

FIG. 6E is an operational flow diagram showing the coin deposit phase of the telephone call process. The coin deposit phase is performed by the pay telephone 110 in order to request and receive the proper coin deposit for the rated international long distance telephone call. The operational flow diagram of FIG. 6E begins with step 639 and flows directly to step 640.

In step 640, the CMS 102 plays a message for the user asking him to deposit a certain amount of coins corresponding to the rate determined above for a certain period of time (the first telephone call period), such as “1 dollar for five minutes.” In step 641, the pay telephone 110 waits for the deposit of the appropriate number of coins into the coin slot/detector 205. In step 642, it is determined whether coins have been deposited into the coin slot/detector 205. If coins have been deposited into the coin slot/detector 205, then control flows to step 644. If coins have not been deposited into the coin slot/detector 205, then control flows to step 643.

In step 643, it is determined whether a threshold of time has passed since the phone began waiting for a coin deposit in step 641. If a threshold of time has passed since the phone began waiting for a coin deposit, then control flows to step 645. If a threshold of time has not yet passed since the phone began waiting for a coin deposit, then control flows back to step 641.

In step 645, the CMS 102 orders the pay telephone 110 to drop the telephone call process and return any coins in escrow. The pay telephone 110 performs as ordered. Control flows directly to step 647, or bridge “A,” which flows directly to step 601 of FIG. 6A.

In step 644, the pay telephone 110 accepts the coins deposited via the coin slot/detector 205. These coins are placed in escrow, which is a location in the pay telephone 110 in which coins may be returned at a later time. In step 646, the pay telephone 110 determines the amount of money that was deposited in the pay telephone 110 via the coin slot/detector 205. This can be accomplished by the coin slot/detector 205 or the processor 210 of the pay telephone 110.

In step 649, the pay telephone 110 compares the amount of money deposited in the coin slot/detector 205 in step 644 with the rate of the telephone call, as determined above. If the correct amount of money was deposited for the first telephone call period according to the determined rate, then control flow to step 650. If an incorrect amount of money was deposited for the first telephone call period, then control flows to step 648. In step 648, the pay telephone 110 enables the earpiece 202 of the handset 203 of the pay telephone 110, such the user can hear the upcoming message of step 640 through the earpiece 202. In step 650, control flows directly to FIG. 6F.

FIG. 6F is an operational flow diagram showing the connection phase of the telephone call process. The connection phase is performed by the pay telephone 110 and the CMS 102 in order to establish a telephone call connection between the calling party 110 and the receiving party 112. The operational flow diagram of FIG. 6F begins with step 651 and flows directly to step 652.

In step 652, the CMS 102 negotiates a connection to the destination number, i.e., telephone 112, via the telephone network 104 and the central office 108. Recall that a connection was already established between the pay telephone 110 and the CMS 102 via the telephone network 104 and the central office 106. In step 653, the pay telephone 110 waits for a collection tone from the CMS 102. A collection tone is preferably a DTMF tone played by the CMS 102 that indicates to the pay telephone 110 that the telephone call has commenced. The pay telephone 110 waits and listens for a particular DTMF that indicates a collection tone. If the correct DTMF tone is not played by the CMS 102, the pay telephone 110 does not hear a collection tone.

In step 654, it is determined whether a collection tone has been received. If a collection tone has been received, then control flows to step 656. If a collection tone has not been received, then control flows to step 655.

In step 655, it is determined whether a threshold of time has passed since the phone began waiting for a collection tone in step 653. If a threshold of time has passed since the phone began waiting for a collection tone, then control flows to step 659. If a threshold of time has not yet passed since the phone began waiting for a collection tone, then control flows back to step 653.

Alternative to receiving a collection tone, in step 658, the pay telephone 110 may receive a busy signal, prerecorded operator message or any other signal indicating that a telephone call connection could not be made. In step 659, the pay telephone 110 drops the telephone call process and returns any coins in escrow. Control flows directly to step 694, or bridge “A,” which flows directly to step 601 of FIG. 6A.

In step 656, the pay telephone 110 receives the collection tone sent by the CMS 102. In step 657, the control flows directly to FIG. 6G.

FIG. 6G is an operational flow diagram showing the first half of the call-in-progress phase of the telephone call process. The call-in-progress phase is performed by the pay telephone 110 and the CMS 102 and encompasses the tasks performed during a telephone call connection between the calling party 110 and the receiving party 112. The operational flow diagram of FIG. 6G begins with step 660 and flows directly to step 661.

In step 661, the caller—pay telephone 110—is connected with the receiving party—the telephone 112. Subsequently, the pay telephone 110 enables the earpiece 202 and the mouthpiece 204 so that the user may hear the call and speak into the mouthpiece 204. In step 663, the CMS 102 starts a call timer to keep track of the first telephone call period.

In step 664, it is determined whether the call has ended due to either of the parties, a bad connection, and more For example, any of the two parties may have hung up their respective telephone or the connection may have been dropped by the telephone communication system 104 due to heavy traffic. If the call has ended, then control flows to step 667. If the call has not ended, the control flows to step 666. Note that at any time during the call process of the second embodiment, the user of pay telephone 110 can end the call process, placing the control flow at step 667.

In step 667, the pay telephone 110 collects any coins in escrow for the first telephone call period. Control flows directly to step 669, or bridge “A,” which flows directly to step 601 of FIG. 6A.

In step 666, it is determined by the CMS 102 whether the first telephone call period has almost expired. That is, it is determined whether the call timer of CMS 102 has reached a predetermined moment in time before the end of the first telephone call period, such as 35-40 before the end of the first telephone call period. If the result of the determination of step 666 is positive, then control flows to step 668. If the result of the determination of step 6.66 is negative, then control flows back to step 664.

In step 668, the pay telephone 110 collects the coins in escrow. Alternative, to step 668, the pay telephone i 10 can be programmed to collect the coins in escrow after a grace period extending past the end of the first telephone call period. In this alternative, the collection of the coins in escrow of step 668 would occur at some time after the end of the first telephone call period, such as after step 677 of FIG. 6H.

In step 670, the CMS 102 sends a rate tone to the pay telephone 110. Preferably the rate tone is a DTMF tone corresponding to a rate. In step 671, the pay telephone 110 calculates a rate for the next telephone call period based on the received rate tone. This is accomplished by accessing a table, database or other data structure describing a correspondence between DTMF tones and telephone call rates.

Step 665, or bridge “B,” flows directly to step 664. In step 672, control flows directly to FIG. 6H.

FIG. 6H is an operational flow diagram showing the second half of the call-in-progress phase of the telephone call process. The call-in-progress phase is performed by the pay telephone 110 and the CMS 102 and encompasses the tasks performed during a telephone call connection between the calling party 110 and the receiving party 112. The operational flow diagram of FIG. 6H begins with step 673 and flows directly to step 674.

In step 673, the CMS 102 plays a message notifying the user that the first telephone call period is about to expire and asking the user to insert additional coins for the next telephone call period. In step 675, the pay telephone 110 waits for the deposit of the appropriate number of coins into the coin slot/detector 205. In step 676, it is determined whether coins have been deposited into the coin slot/detector 205. If coins have been deposited into the coin slot/detector 205, then control flows to step 678. If coins have not been deposited into the coin slot/detector 205, then control flows to step 677.

In step 677, it is determined whether the first telephone call period has expired since the phone began waiting for a coin deposit in step 675. If the first telephone call period has expired since the phone began waiting for a coin deposit, then control flows to step 679. If the first telephone call period has not expired since the phone began waiting for a coin deposit, then control flows back to step 675.

In step 540, the CMS 102 orders the pay telephone 110 to drop the telephone call process. The pay telephone 110 performs as ordered. Control flows directly to step 681, or bridge “A,” which flows directly to step 601 of FIG. 6A.

In step 678, the pay telephone 110 disables the earpiece 202 of the handset 203 of the pay telephone 110. In step 680, the pay telephone 110 accepts the coins deposited via the coin slot/detector 205. These coins are placed in escrow, which is a location in the pay telephone 110 in which coins may be returned at a later time. Also, in step 680, the pay telephone 110 enables the earpiece 202 of the handset 203. In step 682, the pay telephone 110 determines the amount of money that was deposited in the pay telephone 110 via the coin slot/detector 205. This can be accomplished by the coin slot/detector 205 or the processor 210 of the pay telephone 110.

In step 683, the pay telephone 110 compares the amount of money deposited in the coin slot/detector 205 in step 680 with the rate of the next telephone call period, as determined above. If the correct amount of money was deposited for the next telephone call period according to the determined rate, then control flows to step 684, or bridge “B.” If an incorrect amount of money was deposited for the next telephone call period, then control flows back to step 674.

V. Exemplary Implementations

While the preferred embodiments are illustratively described above, the invention is not so limited. The present invention is applicable to any information processing system or computer system that has the capability to perform the processes of a pay telephone 110 or a CMS 102.

Further, the present invention can be realized in hardware, software, or a combination of hardware and software. A system according to a preferred embodiment of the present invention can be realized in a centralized fashion in one information processing system, or in a distributed fashion where different elements are spread across several interconnected systems. Any kind of information processing system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product that includes all the features enabling the implementation of the methods described herein, and which, when loaded in a system, is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A system may include, inter alia, one or more information processing systems and/or computers and at least a machine-readable or computer-readable medium, allowing a system, to read data, instructions, messages or message packets, and other information from the machine-readable or computer-readable medium. The machine-readable or computer-readable medium may include non-volatile memory, such as ROM, Flash memory, Disk drive memory, CD-ROM, and other permanent storage. Additionally, a machine-readable or computer-readable medium may include, for example, volatile storage such as RAM, buffers, cache memory, and network circuits. Furthermore, the machine-readable or computer-readable medium may include information in a transitory state medium such as a network link and/or a network interface, including a wired network or a wireless network, that allow a computer system to read such computer-readable information.

FIG. 7 is a block diagram of a computer system useful for implementing an embodiment of the present invention. The computer system of FIG. 7 includes processor 704 that is connected to a communication infrastructure 702 (e.g., a communications bus, cross-over bar, or network). At least one cache 705 is also connected to the communication infrastructure 702. Various software embodiments are described in terms of this exemplary computer system. After reading this description, it will become apparent to a person of ordinary skill in the relevant art(s) how to implement the invention using other computer systems and/or computer architectures.

The computer system can include a display interface 708 that forwards graphics, text, and other data from the communication infrastructure 702 (or from a frame buffer not shown) for display on the display unit 710. The computer system also includes a main memory 706, preferably random access memory (RAM), and may also include a secondary memory 712. The secondary memory 712 may include, for example, a hard disk drive 714 and/or a removable storage drive 716, representing a floppy disk drive, a magnetic tape drive, an optical disk drive, and more The removable storage drive 716 reads from and/or writes to a removable storage unit 718 in a manner well known to those having ordinary skill in the art. Removable storage unit 718, represents a floppy disk, magnetic tape, optical disk, and more, which is read by and written to by removable storage drive 716. As will be appreciated, the removable storage unit 718 includes a computer usable storage medium having stored therein computer software and/or data.

In alternative embodiments, the secondary memory 712 may include other similar means for allowing computer programs or other instructions to be loaded into the computer system. Such means may include, for example, a removable storage unit 722 and an interface 720. Examples of such may include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to the computer system.

The computer system may also include a communications interface 724. Communications interface 724 allows software and data to be transferred between the computer system and external devices. Examples of communications interface 724 may include a modem, a network interface (such as an Ethernet card), a communications port, a PCMCIA slot and card, and more Software and data transferred via communications interface 724 are in the form of signals which may be, for example, electronic, electromagnetic, optical, or other signals capable of being received by communications interface 724. These signals are provided to communications interface 724 via a communications path (i.e., channel) 726. This channel 726 carries signals and may be implemented using wire or cable, fiber optics, a phone line, a cellular phone link, an RF link, and/or other communications channels.

In this document, the terms “computer program medium,” “computer-usable medium,” “machine-readable medium” and “computer-readable medium” are used to generally refer to media such as main memory 706 and secondary memory 712, removable storage drive 716, a hard disk installed in hard disk drive 714, and signals. These computer program products are means for providing software to the computer system. The computer-readable medium allows the computer system to read data, instructions, messages or message packets, and other computer-readable information from the computer-readable medium. The computer-readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer-readable medium may include computer-readable information in a transitory state medium such as a network link and/or a network interface, including a wired network or a wireless network, that allow a computer to read such computer-readable information.

Computer programs (also called computer control logic) are stored in main memory 706 and/or secondary memory 712. Computer programs may also be received via communications interface 724. Such computer programs, when executed, enable the computer system to perform the features of the present invention as discussed herein. In particular, the computer programs, when executed, enable the processor 704 to perform the features of the computer system. Accordingly, such computer programs represent controllers of the computer system.

VI. Conclusion

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method on a telephone for facilitating rated telephone calls, comprising:
receiving a destination telephone number for a telephone call;
determining a first rate for the telephone call based on the destination number;
connecting to a call management system;
receiving a DTMF tone from the call management system, the DTMF tone corresponding to a second rate for the telephone call; and
wherein if the first rate is identical to the second rate, connecting to the destination number.

2. The method of claim 1, wherein the determining step comprises:
determining a first rate for the telephone call based on the destination number by using a predefined rate table.

3. The method of claim 2, further comprising a step before the second connecting step of:
determining the second rate by using a lookup table showing a correspondence between DTMF tones and rates.

4. An information processing system for facilitating rated telephone calls, comprising:
an interface for receiving a destination telephone number for a telephone call;
a rate table for use by a processor for determining a first rate for the telephone call based on the destination number;
a telephony processing system for connecting to a call management system;
a DTMF tone received from the call management system, the DTMF tone corresponding to a second rate for the telephone call; and
a processor for determining if the first rate is identical to the second rate.

5. The information processing system of claim 4, further comprising:
a lookup table showing a correspondence between DTMF tones and rates, used for determining the second rate.

6. A method on an information processing system for facilitating rated telephone calls, comprising:
connecting to a telephone to initiate a telephone call;
sending a DTMF tone to the telephone, the DTMF tone corresponding to a rate for the telephone call; and
connecting the telephone to the destination number.

7. The method of claim 6, further comprising a step before the sending step of:
determining a rate for the telephone call by using a predefined rate table.

8. The method of claim 7, further comprising:
sending a collection tone to the telephone when a telephone connection has been made to the destination number.
